(19) United States
(12) Patent Application Publication
(10) Pub. No.: US 2026/0271026 A1
(43) Pub. Date: Sep. 10, 2026

(54) SIDELINK TRANSMISSION OF WIRELESS MESSAGES USING STORE-AND-FORWARD OPERATIONS

(71) Applicant: QUALCOMM Incorporated, San Diego, CA (US)

(72) Inventors: Stephen William EDGE, Escondido, CA (US); Hong CHENG, Basking Ridge, NJ (US); Francesco PICA, San Diego, CA (US)

(21) Appl. No.: 19/072,408

(22) Filed: Mar. 6, 2025

(51) Int. Cl. H04W 72/25; H04W 4/90

(52) U.S. Cl. CPC H04W 72/25; H04W 4/90

(57) ABSTRACT

Techniques are described for forwarding emergency alert messages between user equipments (UEs) using store-and-forward operations. In some aspects, at a first time, a UE may receive and store an emergency alert message that indicates an alerting event. The UE may transmit, to a second UE via a sidelink interface and at a second time that occurs after the first time, an indication of the emergency alert message and a store-and-forward operation. The UE may transmit, via the sidelink interface and at a third time that occurs at or after the second time, the emergency alert message to the second UE. The transmission may occur via unicast or broadcast and may be conditional, such as based on the UE being out of network coverage or being within a certain geographic area. The second UE may similarly transmit the emergency alert message to additional UEs. Numerous other aspects are described.

### FIELD OF THE DISCLOSURE

Aspects of the present disclosure generally relate to wireless communication and specifically relate to techniques, apparatuses, and methods associated with sidelink transmission of wireless messages using store-and-forward operations.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

During a disaster event which may include both natural and man-made disasters (e.g., wildfires, hurricanes, tornadoes, pandemics, earthquakes, volcanic eruptions, tsunamis, acts of terrorism, acts of war, nuclear power plant accidents), a wireless message, such as a wireless emergency alert (WEA) message or another type of emergency alert message, may be transmitted from one or more network nodes to user equipments (UEs) in an affected (or likely to be affected) area. The wireless message may indicate a warning associated with the disaster event.

### SUMMARY

Some aspects described herein relate to a method of wireless communication performed by a first user equipment (UE). The method may include receiving, at a first time, an emergency alert message that indicates an alerting event. The method may include transmitting, to a second UE via a sidelink interface and at a second time that occurs after the first time, an indication of both the emergency alert message and a store-and-forward operation associated with the emergency alert message. The method may include transmitting, via the sidelink interface and at a third time that occurs at or after the second time, the emergency alert message to the second UE in accordance with the store-and-forward operation.

Some aspects described herein relate to a non-transitory computer-readable medium that stores a set of instructions for wireless communication by a first UE. The set of instructions, when executed by one or more processors of the first UE, may cause the first UE to receive, at a first time, an emergency alert message that indicates an alerting event. The set of instructions, when executed by one or more processors of the first UE, may cause the first UE to transmit, to a second UE via a sidelink interface and at a second time that occurs after the first time, an indication of both the emergency alert message and a store-and-forward operation associated with the emergency alert message. The set of instructions, when executed by one or more processors of the first UE, may cause the first UE to transmit, via the sidelink interface and at a third time that occurs at or after the second time, the emergency alert message to the second UE in accordance with the store-and-forward operation.

Some aspects described herein relate to a first UE. The first UE may include a processing system. The processing system may include one or more processors and one or more code-storing memories coupled with the one or more processors. The processing system may be configured to cause the first UE to receive, at a first time, an emergency alert message that indicates an alerting event. The processing system may be configured to cause the first UE to transmit, to a second UE via a sidelink interface and at a second time that occurs after the first time, an indication of both the emergency alert message and a store-and-forward operation associated with the emergency alert message. The processing system may be configured to cause the first UE to transmit, via the sidelink interface and at a third time that occurs at or after the second time, the emergency alert message to the second UE in accordance with the store-and-forward operation.

Some aspects described herein relate to an apparatus for wireless communication. The apparatus may include means for receiving, at a first time, an emergency alert message that indicates an alerting event. The apparatus may include means for transmitting, to a UE via a sidelink interface and at a second time that occurs after the first time, an indication of both the emergency alert message and a store-and-forward operation associated with the emergency alert message. The apparatus may include means for transmitting, via the sidelink interface and at a third time that occurs at or after the second time, the emergency alert message to the UE in accordance with the store-and-forward operation.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims.

Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram of an example of a wireless emergency alert (WEA) system.

FIG. 4A is a diagram of an example of an alert message flow using a WEA transport service.

FIG. 4B shows an example user interface displaying an emergency alert.

FIG. 5 is a diagram of an example of a network architecture for providing wireless emergency alerts.

FIGS. 6A and 6B are diagrams illustrating example scenarios associated with transmitting emergency alert messages during an alerting event.

FIGS. 7 through 9 are diagrams illustrating examples associated with transmitting emergency alert messages during an alerting event.

FIG. 10 is a diagram illustrating an example process performed, for example, at a user equipment (UE) or an apparatus of a UE.

FIG. 11 is a diagram of an example apparatus for wireless communication.

FIG. 12 is a diagram illustrating an example of a network node in communication with a UE in a wireless network.

Like reference symbols in the various drawings indicate like or similar elements, in accordance with certain example implementations. In addition, multiple instances of an element may be indicated by following a first number for the element with a letter. For example, multiple instances of an element 120 may be indicated as 120a, 120b, 120c, etc. When referring to such an element using the first number (e.g., without the following letter), any instance of the element is to be understood (e.g., element 120 in the previous example would refer to elements 120a, 120b, and 120c).

### DETAILED DESCRIPTION

During a disaster event which may include both natural and man-made disasters (e.g., wildfires, hurricanes, tornadoes, pandemics, earthquakes, volcanic eruptions, tsunamis, acts of terrorism, acts of war, nuclear power plant accidents), a wireless message, such as a wireless emergency alert (WEA) message or another type of emergency alert message, may be transmitted from one or more network nodes to user equipments (UEs) in an affected (or likely to be affected) area. The wireless message may indicate a warning associated with the disaster event. However, the disaster event may damage or destroy some network nodes (or otherwise make some network nodes inoperable), such that the network nodes may be unable to broadcast the wireless message to UEs in the affected area. An emergency system, such as a WEA system, may also be disabled by the same disaster event that the WEA system is intended to protect against, which may result in some or all UEs in the affected area not receiving the wireless message from a network node.

The emergency system may be upgraded to overcome such limitations. For example, the emergency system may be upgraded to support the transmission of wireless messages via a satellite, where the satellite is less likely to be impaired or affected by the disaster event (though ground stations for a satellite may still be affected). However, not all UEs may have a satellite capability, and in some cases, access to satellites may be restricted. As another example, the emergency system may be upgraded to support the transmission of wireless messages via sidelink signaling, also referred to as device to device (D2D) signaling. In this example, a wireless message may be relayed from a UE with wireless coverage (e.g., with access to a network node that was not impaired) to other UEs without wireless coverage, using sidelink signaling. However, using sidelink signaling to extend an effective message coverage may be limited because a UE relaying a wireless message must necessarily have access to a network node. Therefore, a wireless coverage area may only be extended outwards by a maximum sidelink signaling distance between a pair of UEs (e.g., 1-3 km).

In some cases, a wireless message may be relayed over a chain of UEs (e.g., 2 or 3 UEs) using sidelink signaling, but the extension of the effective message coverage area may still be limited by a maximum number of UEs allowed or included in the chain or a requirement that UEs are within a certain distance from each other when an initial UE receives a wireless message from the network node. Further, relaying wireless messages using sidelink signaling may be limited to being relayed in real-time, so only UEs that are proximately located to a transmitter or relay UE (e.g., within 1-3 km of the transmitter or relay UE) are able to receive the wireless message. As a result, during the disaster event, relying on sidelink signaling with such limitations may limit a number of UEs that are able to receive the wireless message using sidelink signaling, which may degrade an overall system performance.

Various aspects relate generally to transmitting wireless messages during or for an alerting event. An alerting event can be a disaster event where people, animals or property are at risk. Additionally, or alternatively, the alerting event can be a milder event where people need to be made aware of the event but where human life, animal life and property are not directly at risk. An example of a disaster event could be a hurricane, tornado or wildfire. An example of an alerting event that is not a disaster event could be total or partial loss of coverage by a public or private communication network, a road closure or cancellation of certain road, rail or airline transport. The WEA system described here is generally intended to support disaster events. However, the wireless messages described here to warn users about alerting events can apply to alerting events that both comprise and do not comprise disaster events. In the description herein, the terms alerting event and disaster event are used interchangeably.

Some aspects of sending wireless messages for an alerting event more specifically relate to transmitting an emergency alert message (e.g., a WEA message) using sidelink signaling. In some examples, a first UE may receive, from a network node via a broadcast, an emergency alert message that indicates a presence of an alerting event. The alerting event may involve a natural disaster, a man-made disaster, a loss of coverage to a wireless network, a road closure or cancellation of a certain transportation. The first UE may receive the emergency alert message at a first time and at a first location. The first UE may store the emergency alert message in a memory of the first UE. The first UE may be in-coverage with the network node when the emergency alert message is received from the network node. The first UE may be a mobile UE, such that the first UE may move from the first location to a second location. At the second location, the first UE may transmit, to a second UE, the emergency alert message in accordance with a store-and-forward operation. Additionally, the first UE may transmit, to the second UE, an indication that the emergency alert message is associated with the store-and-forward operation. The first UE may transmit the emergency alert message to the second UE when the second UE is in a target area for the emergency alert message. The first UE may transmit the emergency alert message at a second time that occurs after the first time. The second UE that receives the emergency alert message may be out-of-coverage with the network node. The first UE may receive the emergency alert message and transmit the emergency alert message using a same RAT or different RATs. The first UE may transmit the emergency alert message using the store-and-forward operation, where the store-and-forward operation may be associated with a diffusion time. The diffusion time may be based at least in part on an extent of a backhaul outage for the network node due to the disaster event or a size of the target area. The target area may be a target WEA area.

Particular aspects of the subject matter described in this disclosure can be implemented to realize one or more of the following potential advantages. In some examples, by using the store-and-forward operation to relay an emergency alert message, instead of only relaying emergency alert messages in real-time, the described techniques can be used by a first UE to relay or forward emergency alert messages to a plurality of UEs within a target area, even in cases that the plurality of UEs within the target area are not geographically close to an in-coverage area. A time needed to forward an emergency alert message to all UEs in a target area may be referred to as a diffusion time, since a process of forwarding an emergency alert message by UEs which move into or around a target area can be similar to a physical process of diffusion. For example, a diffusion time may be less than a minute to several hours, depending on a size of the target area, a speed and mobility of the UEs which forward the emergency alert message and a density of UEs in the target area. The first UE may be able to store the emergency alert message received from a network node, and then the first UE may forward the emergency alert message to other UEs within the target area (e.g., UEs that have not already received the emergency alert message). Typically, a sidelink interface is intended to provide real-time access to a wireless network. However, since the first UE may move to different locations within a target area, which may be larger than a coverage area of a network node, an effective message coverage may be extended beyond a maximum sidelink signaling distance (e.g., beyond 1-3 km). As a result, a larger number of UEs within a target area may be able to receive the emergency alert message, which may improve an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

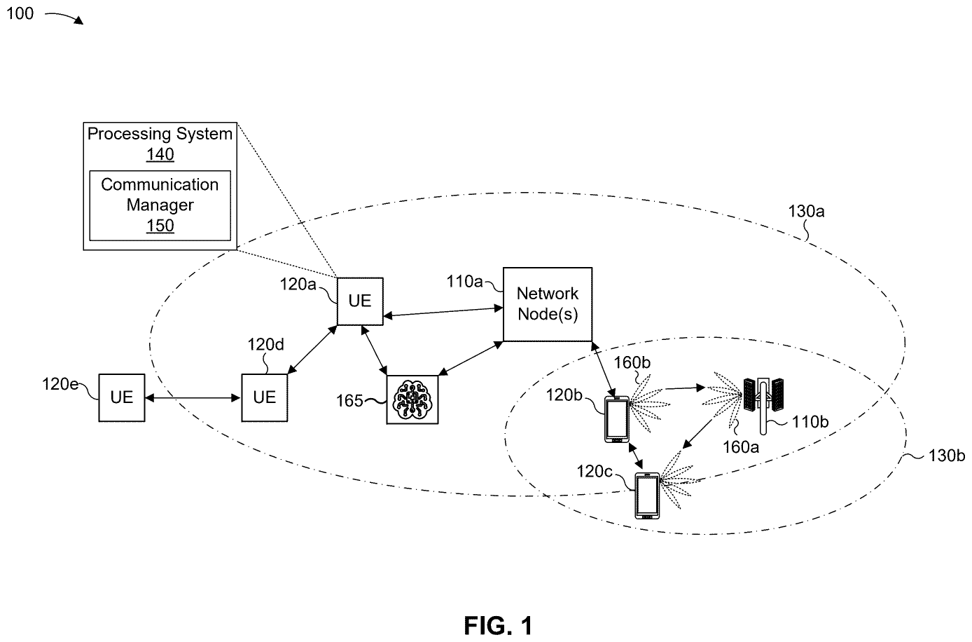

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, a UE 120c, a UE 120d, and a UE 120e (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system. A processing system (for example, the processing system 140) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 may include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 may include or be coupled with one or more modems (such as a cellular (for example, a 5G or 6G compliant) modem). In some examples, one or more processors of the processing system 140 may include or implement one or more of the modems. The processing system 140 also may include or be coupled with multiple radios (collectively “the radio”), multiple RF chains, or multiple transceivers, each of which may in turn be coupled with one or more of multiple antennas. In some examples, one or more processors of the processing system 140 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using a processing system, such as the processing system 140) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using a processing system such as the processing system 140, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, by using a processing system such as the processing system 140 or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 140 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 140 or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using a processing system such as the processing system 140 or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi-co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by a processing system at the network node 110), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some examples, two or more UEs 120 (for example, shown as UE 120a and UE 120d or the UE 120d and the UE 120e) may communicate directly with one another using sidelink communications (for example, without communicating by way of a network node 110 as an intermediary). As an example, the UE 120a may directly transmit data, control information, or other signaling as a sidelink communication to the UE 120d. This is in contrast to, for example, the UE 120a first transmitting data in an uplink communication to a network node 110, which then transmits the data to the UE 120d in a downlink communication. In various examples, the UEs 120 may transmit and receive sidelink communications using peer-to-peer (P2P) communication protocols, D2D communication protocols, vehicle-to-everything (V2X) communication protocols (which may include vehicle-to-vehicle (V2V) protocols, vehicle-to-infrastructure (V2I) protocols, or vehicle-to-pedestrian (V2P) protocols), or mesh network communication protocols. In some deployments and configurations, a network node 110 may schedule or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

In some examples, any wireless communication device that relays communications may be referred to as a relay node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the UE 120a may communicate with the network node 110a (for example, a macro network node) and the UE 120d in order to facilitate communication between the network node 110a and the UE 120d. Additionally, the UE 120d may relay communications between the UE 120a and the UE 120e (for example, when the UE 120e is outside a coverage area of the cell 130a provided by the network node 110a). A UE 120 that relays communications may be referred to as a UE relay, a relay UE, or an intermediate relay UE, among other examples.

In some aspects, the UE 120 may include a communication manager 150. As described in more detail elsewhere herein, the communication manager 150 may receive, at a first time, an emergency alert message that indicates an alerting event; transmit, to a second UE via a sidelink interface and at a second time that occurs after the first time, an indication of both the emergency alert message and a store-and-forward operation associated with the emergency alert message; and transmit, via the sidelink interface and at a third time that occurs at or after the second time, the emergency alert message to the second UE in accordance with the store-and-forward operation. Additionally, or alternatively, the communication manager 150 may perform one or more other operations described herein.

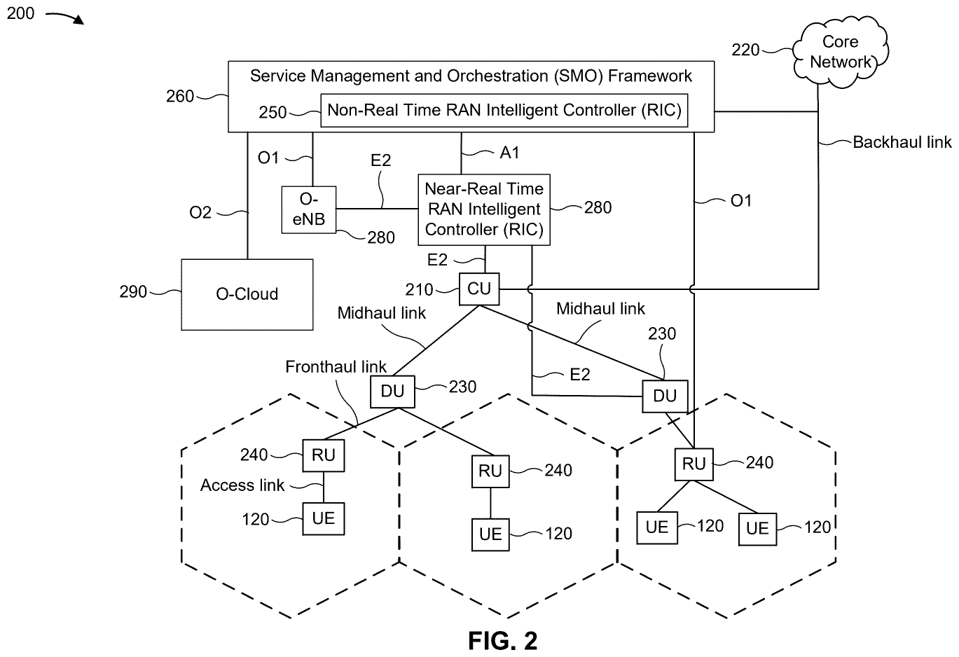

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

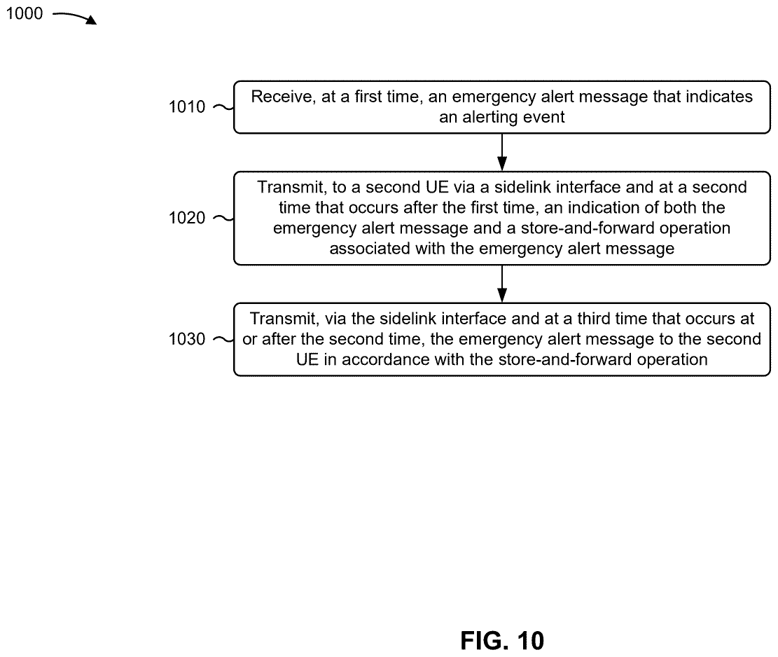

The network node 110, the UE 120, the processing system 140 of the UE 120, the CU 210, the DU 230, the RU 240, or any other component(s) of FIG. 1 or FIG. 2 may implement or enable one or more techniques, or may perform or enable to be performed one or more operations associated with sidelink transmission of wireless messages using store-and-forward operations, as described in more detail elsewhere herein. For example, a processing system of the network node 110, the processing system 140 of the UE 120, the CU 210, the DU 230, or the RU 240 may perform, enable or direct operations of, for example, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 140) of the UE 120, may cause the one or more processors to perform process 1000 of FIG. 10, or other processes as described herein. In some examples, executing instructions may include running the instructions, converting the instructions, compiling the instructions, or interpreting the instructions, among other examples.

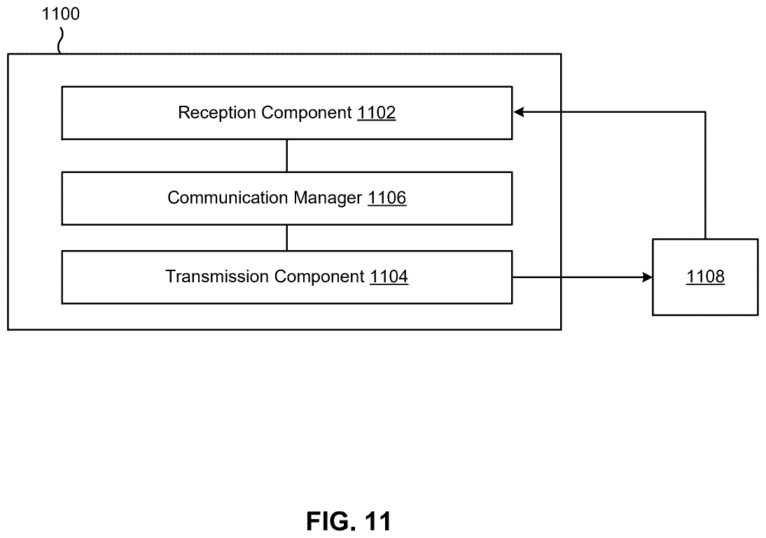

In some aspects, a first UE includes means for receiving, at a first time, an emergency alert message that indicates an alerting event; means for transmitting, to a second UE via a sidelink interface and at a second time that occurs after the first time, an indication of both the emergency alert message and a store-and-forward operation associated with the emergency alert message; or means for transmitting, via the sidelink interface and at a third time that occurs at or after the second time, the emergency alert message to the second UE in accordance with the store-and-forward operation. The means for the first UE to perform operations described herein may include, for example, one or more of a communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

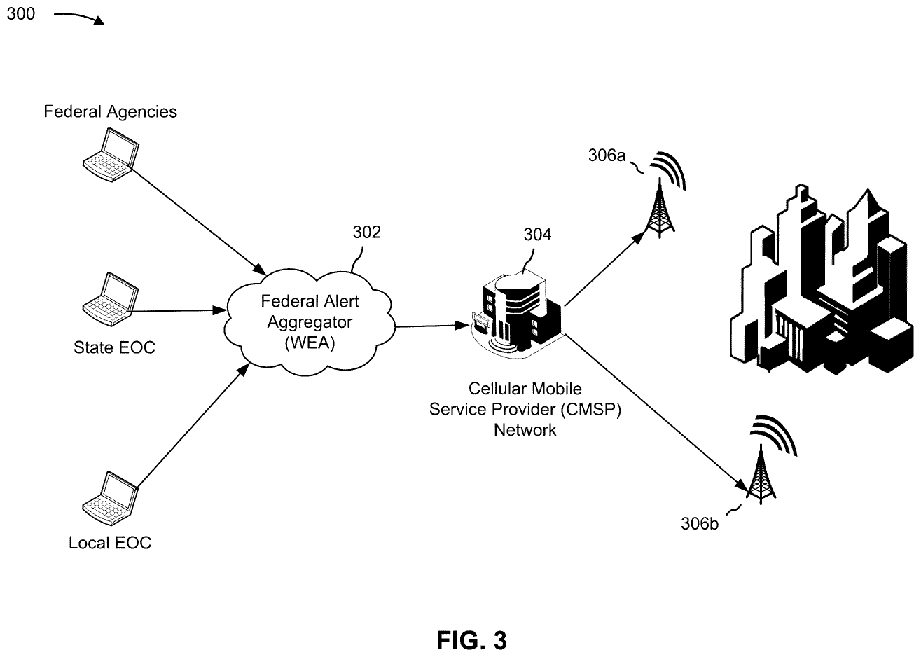

FIG. 3 is a diagram of an example 300 of a WEA system. In the example 300, the WEA system may be configured to utilize radio frequency broadcast technology to provide geographically-targeted and timely alert messages to UEs (e.g., UEs 120). An alert message may be referred to as an emergency alert message, and may correspond to a message that is intended to provide the recipient with information regarding an emergency and that meets the requirements of regional regulations. For example, the WEA system may generate and provide alert messages to notify users about a geographically specific emergency such as an earthquake, a tsunami, a flood, a tornado, a wildfire, an act of terrorism, a child abduction (e.g., an AMBER alert), a possible nuclear missile attack, local riots, or other types of emergency events.

In many countries, cellular mobile service providers (CMSPs) 304 (sometimes referred to herein as “providers”) may be required to transmit alert messages that comply with agreed-upon standards, protocols, or procedures. As an example, standards, protocols, or procedures applicable to WEA support in the United States may be provided by the Alliance for Telecommunications Industry Solutions (ATIS), the Telecommunications Industry Association (TIA), or joint ATIS/TIA groups. An example of a related standard is Joint ATIS/TIA Commercial Mobile Alert System (CMAS) Federal Alert Gateway to CMSP Gateway Interface Specification (J-STD-101). The alert message processes controlled by a CMSP 304 may also be required to comply with local or federal government regulations (e.g., regulations adopted by the U.S. Federal Communications Commission (FCC) and state or county emergency preparedness procedures). Government collaboration with the WEA system may be provided by the FCC, Federal Emergency Management Agency (FEMA), or Department of Homeland Security (DHS).

In operation, alert messages may originate from federal agencies, local emergency operations centers (EOCs), and state EOCs. Alert messages may also originate from other sources. An alert message may be triggered by various types of emergencies, such as an earthquake, a tsunami, a flood, a tornado, a wildfire, an act of terrorism, acts of war, civil unrest, or child abduction (e.g., an AMBER alert). Alert messages originating from various sources (e.g., federal agencies, local EOCs, and state EOCs) may be provided to an alert aggregator 302. In some configurations, the alert aggregator 302 may authenticate the alert messages. Authentication may involve checking the authenticity of the alert message to confirm that the alert message was transmitted by an authorized source, in order to prevent unauthorized sources (e.g., terrorist, hackers, hostile foreign states, etc.) from causing fraudulent alert messages to be disseminated to UEs using the WEA system. The alert aggregator 302 may provide the alert messages to the CMSP 304 (and possibly to other CMSPs), which is prepared to transmit alert messages to UEs (e.g., UEs 120) accessing CMSP 304 via one or more network transmitters 306a-b which may correspond to network nodes 110 (e.g., which may include cellular base stations, base stations with satellite access or satellite capability and possibly other transmitters such as WiFi access points). In some configurations, the alert aggregator 302 may be administered by a governmental entity (e.g., a federal, state, local agencies).

The CMSP 304 may include one or more systems or personnel to determine or verify the severity of an emergency (referred to as “severity information”) as well as a geographic area associated with the emergency, which may also be provided by the alert aggregator 302. This geographic area may be referred to as the impacted area, impact area, target area, affected area, or target geographic area, these terms being used synonymously herein. For example, one or more systems and personnel in the CMSP 304 may verify that a notification received from the alert aggregator 302 regarding a potential tornado touch down has a high severity, and that the corresponding impacted area (e.g., the predicted tornado touch down area) includes areas covered by the CMSP 304 network resources, such as the transmitter 306a and the transmitter 306b. A provider may utilize various components of the CMSP 304 network to generate and transmit an alert message to UEs (e.g., UEs 120) within the target geographic area (or within a portion of the target geographic area served by CMSP 304). In an example, the WEA system may utilize broadcast technology such that one or more alert messages may be provided simultaneously to all UEs in the target geographic area.

To broadcast the alert messages to UEs in the target geographic area, a transmitter 306 may transmit a plurality of segments that correspond to the alert message. That is, the transmitter 306 may divide the alert message into a plurality of segments (e.g., which may correspond to system information blocks (SIBs)) according to a granularity, which may correspond to a maximum size of a field, parameter or system information block within a signal that carries alert messages. Then, the transmitter 306 may broadcast the plurality of segments. To receive and decode the alert messages, a UE may receive, decode, and store each of the plurality of segments, and then combine the plurality of segments to obtain the alert message. In some cases, the transmitter 306 may include an indication, within each of the segments, of a segment number associated with that segment. Accordingly, a receiving device may combine the segments based on the segment numbers associated with each of the plurality of segments. Additionally, the transmitter 306 may include an indication, within each of the segments, of whether the segment is a last segment associated with the alert message. A receiving UE may determine to combine the plurality of received segments based on receiving a segment that includes an indication that the segment is a last segment associated with the alert message.

In some cases, a UE that receives a wireless message (e.g., an emergency alert message, an alert message) from a transmitter 306 may relay the wireless message (e.g., to one or more other UEs within the target geographic area) using sidelink signaling. In some examples, a first UE may receive, from the transmitter 306a or the transmitter 306b, a wireless message.

In one example, the first UE may relay the wireless message immediately to one or more other UEs (e.g., the first UE may perform an immediate broadcast of the received alert message). Here, the first UE may broadcast each of the plurality of segments associated with a wireless message upon receiving each of the plurality of segments from a transmitter 306. That is, the first UE may immediately broadcast the alert message (e.g., via a sidelink broadcast channel) without first combining the plurality of the segments of the wireless message. Here, the first UE may be configured to perform the immediate broadcast of received alert messages. For example, the first UE may be authorized to perform 5G ProSe UE-to-Network relaying for public warning system (PWS) messages (e.g., wireless messages, emergency alert messages, WEA messages). The first UE may determine to perform the immediate broadcast of the received alert message based on a network node (e.g., that includes the transmitter 306a or the transmitter 306b) using an RRC SIB to broadcast each of the plurality of segments associated with a wireless message (e.g., a SIB6, SIB7, or SIB8 for broadcast using 5G NR). Then, the first UE may receive each segment of the wireless message using the RRC SIB. By immediately broadcasting the received wireless message, a UE that is remote (e.g., a 5G ProSe remote UE) may receive the wireless message even without a connection to a UE-to-Network relay UE (e.g., a 5G ProSe UE-to-Network relay UE).

If the first UE does not have a destination layer-2 broadcast identifier, the first UE may forward the wireless message (e.g., PWS SIBs) to a remote UE via a unicast link (e.g., instead of broadcasting the wireless message). In some cases (e.g., where the remote UE establishes a unicast connection with the first UE), the remote UE may discover a source Public Land Mobile Network (PLMN), a tracking area code (TAC), or cell identifier from performing a discovery procedure with the first UE. Additionally, the first UE may perform duplication detection on wireless messages received from a transmitter 306a or a transmitter 306b to suppress a broadcasting of duplicate messages (e.g., of duplicate messages received over a downlink). Additionally, or alternatively, a remote UE may also perform the duplication detection to detect duplicate messages received over a sidelink (e.g., over a PC5 interface) or a downlink (e.g., over a Uu interface).

In another example, the first UE may relay the wireless message to one or more other UEs at one or more later times, which may be referred to as deferred relaying. Here, the first UE may combine the plurality of segments to obtain the wireless message, and then the first UE may store the wireless message (e.g., within a memory of the first UE). The first UE may be a mobile UE, such that the first UE may move from a first location to a second location. At the second location, the first UE may transmit, to a second UE, the wireless message in accordance with a store-and-forward operation. Additionally, the first UE may transmit, to the second UE, an indication that the wireless message is associated with the store-and-forward operation. The first UE may transmit the wireless message to the second UE when the second UE is in a target geographic area for the wireless message. Additionally, the second UE that receives the wireless message may be out-of-coverage (e.g., may be unable to receive the broadcast alert messages from the transmitter 306a or the transmitter 306b).

As indicated above, FIG. 3 is provided as an example. Other examples may differ from what is described with regard to FIG. 3.

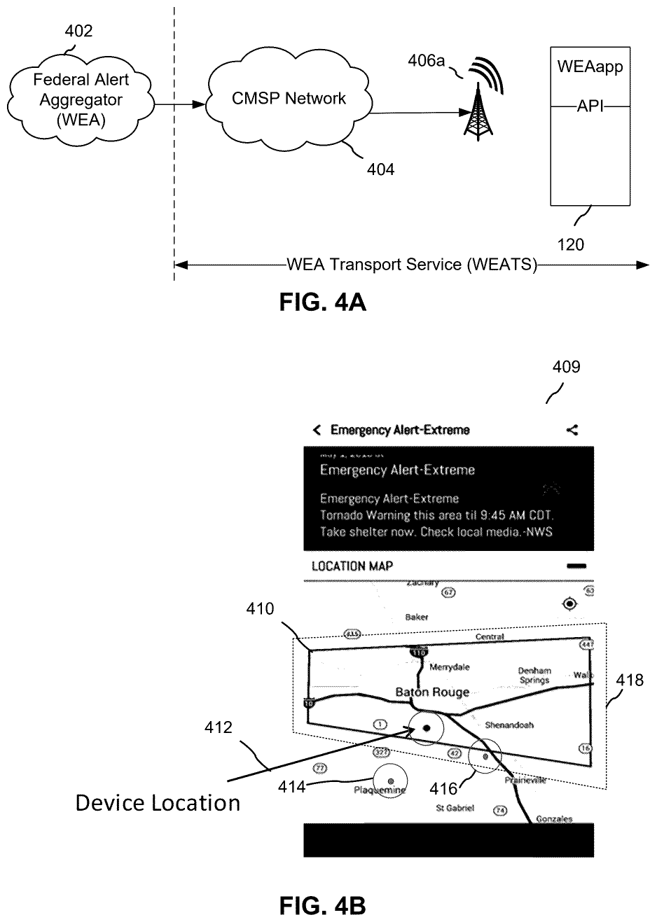

FIG. 4A is a diagram of an example of an alert message flow using a WEA transport service. As shown in FIG. 4A, an alert message flow may use a WEA transport service (WEATS). An alert aggregator 402 may be configured to receive alert information from verified sources such as federal agencies and state/local EOCs (not shown in FIG. 4A). The alert information is then provided to a CMSP network 404. The CMSP network 404 may be configured to generate alert messages including geographic boundaries and broadcast the alert messages to one or more UEs 120 via one or more transmitters 406a (e.g., which may comprise network nodes 110). For example, the alert message may include a field or parameter that indicates a geographical area where the alert message is valid (e.g., a warningAreaCoordintesSegment field or information element). The alert message may correspond to a CMAS message or notification, an Earthquake and Tsunami Warning System (ETWS) message or notification, a WEA message, or some other type of wireless message.

The alert messages may include one or more additional fields or parameters (e.g., in addition to a field that indicates geographic boundaries). For example, the alert message may include a data coding scheme field (e.g., a dataCodingScheme field or information element) that indicates an alphabet or coding language used for the alert message. Additionally, the alert message may include a message segment field (e.g., a warningMessageSegment field or information element) that carries a segment of the alert message (e.g., a segment of the Warning Message Contents information element). The alert message may also include a segment number field (e.g., a warningMessageSegmentNumber field or information element) that indicates the segment number of the alert message (e.g., the CMAS warning message segment, the ETWS message segment) and a segment type field (e.g., a warningMessageSegmentType field or information element) that indicates whether the segment of the alert message is the last segment of the alert message.

Additionally, the alert message may include a message identifier field (e.g., a messageIdentifier field or information element) that identifies a source of the alert message and a type of the alert message notification. For example, the message identifier field may indicate that the source of the alert message is an “Automotive Association” source and that the type of the alert message is a “Traffic Report” type. A mobile equipment (e.g., a UE) may attempt to receive messages (e.g., CBS messages, alert messages, other warning messages) that have message identifiers that are within a search list stored at the mobile equipment. For example, the mobile equipment may store a list of message identifiers (e.g., stored within a file on a subscriber identity module (SIM), stored within a file in the mobile equipment), and the mobile equipment may attempt to receive alert messages having a message identifier that is within the stored list of message identifiers. In some cases, a mobile equipment may have restricted capabilities with respect to the number of message identifiers the mobile equipment is capable of attempting to receive. Here, the mobile equipment may prioritize attempting to receive alert messages having message identifiers that are stored within a file at the mobile equipment.

In some cases, more than one alert message may originate from the same source and be of the same type. Here, a serial number field (e.g., a serialNumber field or information element) within the alert message may distinguish the various alert messages.

The serial number field may identify a particular alert message (e.g., a cell broadcast service (CBS) message) from the source of the alert message and type indicated by the message identifier field. In some cases, the alert message may be one to fifteen pages in length. The serial number field within the alert message may be altered every time the alert message with a given message identifier is changed. The serial number field may carry a two-bit geographical scope indication, a 10-bit message code, and a four-bit update number. In one example, the serial number field may include two octets (e.g., two 8-bit indications). Two bits in the first octet (e.g., the seventh and eighth bits in the first octet) may carry the geographical scope indication, the remaining bits in the first octet and four bits in the second octet (e.g., the eighth through the fifth bits in the second octet) may carry the message code, and the remaining four bits in the second octet (e.g., the fourth through the first bits in the second octet) may carry the update number.

The geographical scope indication within the serial number field may indicate the geographical area over which the message code (e.g., within the serial number field) is unique, and the display mode for the alert message. The alert message may not be broadcast by all cells within the geographical area. When two alert messages are received with identical serial number and message identifier fields in two different cells, the geographical scope indication may be used to determine if the alert messages are indeed identical. The message code within the serial number field may differentiate between alert messages from the same source and type (e.g., alert messages with the same message identifier). In some cases, a PLMN or standalone non-public network (SNPN) operator may allocate the message codes. The message code may identify different message themes. For example, if the message identifier of an alert message indicates that the source of the alert message is “Automotive Association,” and the type of the alert message is “Traffic Reports,” the message code within the serial number field may indicate that the alert message theme is a “Crash on A1 J5,” “Cow on A32 J4,” or a “Slow vehicle on M3 J3.”

The update number within the serial number field may indicate a change of the alert message content of the same alert message (e.g., an alert message such as a CBS message that has a same message identifier, geographical scope, and message code). That is, the update number may differentiate between older and newer versions of the same alert message within the indicated geographical area. A new alert message may have an update number of “0000.” Additionally, the update number may increment by 1 for each update of the alert message.

As indicated above, FIG. 4A is provided as an example. Other examples may differ from what is described with regard to FIG. 4A.

FIG. 4B shows an example user interface displaying an emergency alert. As shown in FIG. 4B, the alert messages 409 may be broadcast (e.g., by network nodes 110) using one or more SIBs (e.g., a SIB6, a SIB7, a SIB8 for 5G NR, or a SIB12 for 4G Long Term Evolution (LTE)). The alert message 409 may include an indication of an impacted area such as a target geographic area defined by a polygon, circle, ellipse, or some other shape (or shapes). A UE 120 may include a software application (e.g., WEAapp) configured to parse and process the information contained in the alert message 409. For example, the UE 120 may execute the WEAapp to display an alert message 409. The alert message 409 may indicate (in this example) a polygon area 410 representing a geographic boundary line of the impacted area indicated in the alert message 409.

The process of displaying the alert message 409 on the UE 120 may be based on a current location of the UE 120. For example, when the UE 120 is located at a first position 412 that is within the polygon area 410, then the UE 120 will display the alert message 409. Conversely, when the UE 120 is located in a second position 414 which is outside the polygon area 410, the alert message 409 may not be displayed. In an example, a boundary area 418, also referred to as a “border area” 418, outside of and surrounding the polygon area 410 may be defined. The boundary area 418 may extend the polygon area 410 outward by a predetermined value (e.g., by outwardly extending the boundary of the impact area by 0.1, 0.2 or 0.5 miles in one, some, or all directions). A UE 120 apparently located at a third position 416 that is outside the polygon area 410 but within the boundary area 418 may optionally display an alert message 409 based on other factors such as the severity of the emergency, user preferences, CMSP preferences, or an uncertainty of the position of the UE 120.

The process of displaying the alert message 409 on the UE 120 may additionally be based on the geographical scope indication within the alert message 409 (e.g., within a serial number field or serial number information element of the alert message 409). That is, the geographical scope indication may indicate, to the UE 120, if the alert message 409 is only cell wide. Here, the UE 120 may display the alert message 409 while the UE 120 is connected to that cell, but the UE 120 may remove the alert message 409 from the screen when the UE 120 selects the next cell. Here, if any additional alert message 409 (or other CBS message) is received in the next cell, the UE 120 may identify the message as “new.” Additionally, the geographical scope indication may indicate, to the UE 120, if the alert message 409 is PLMN or SNPN wide. Here, the UE 120 may display the alert message 409 even if the UE 120 selects another cell. That is, the UE 120 may not identify the alert message 409 as “new” (or any alert message as “new”) unless the message code or update number associated with the alert message 409 changes in the newly selected cell of the PLMN or SNPN. The alert message 409 may be relevant to the PLMN or SNPN in which it is broadcast, so any change of PLMN (including a change to another PLMN which is an ePLMN) or SNPN means the alert message 409 (or other type of alert message) is “new.”

Additionally, the geographical scope indication may indicate whether the alert message is tracking area wide (e.g., in E-UTRAN or in NG-RAN). Here, a message (e.g., a CBS message or other warning message) with the same message code and update number may not be “new” in the next cell according to whether the next cell is in the same tracking area as the current cell.

In some cases, the geographical scope indication may be jointly coded with a display mode associated with the alert message 409. Here, the process of displaying the alert message 409 on the UE 120 may be based, at least in part, on the display mode associated with the alert message 409 and indicated within a serial number field or serial number information element of the alert message 409. The display mode may indicate whether the alert message 409 is supposed to be on the display on the UE 120 all of the time (e.g., the display mode may be an “immediate” display mode) or only when a user of the UE 120 wants to see it (e.g., the display mode may be a “normal” display mode). In either case, the alert message may be displayed in response to the message identifier of the alert message is contained within the search list stored by of the UE 120. These display modes may be indicative of intended use, without indicating a mandatory requirement or constraining the detailed implementation by mobile manufacturers. The user of the UE 120 may be able to select activation of the different display modes.

An example of the jointly coded geographical scope indication and the display mode is illustrated below in Table 1. In the example illustrated in Table 1, a display mode of “immediate” may correspond directly displaying the alert message 409 at the UE 120 by default, and a display mode of “normal” may correspond to displaying the alert message 409 at the UE 120 in response to user interaction, by default. Additionally, the value of “00” within the geographical scope field may generally be used by network operators for base station (or other network node) identifiers, but the code “00” may also be used for other applications. That is, the value of “00” within the geographical scope field may take precedence over the setting of the message class.

TABLE 1
Geographical Scope Field Values

| Geographical | | |
|---|---|---|
| Scope Field | | |
| Value | Display Mode | Geographical Scope |
| 00 | Immediate | Cell Wide |
| 01 | Normal | PLMN or SNPN Wide |
| 10 | Normal | Tracking Area Wide |
| 11 | Normal | Cell Wide |

As indicated above, FIG. 4B is provided as an example. Other examples may differ from what is described with regard to FIG. 4B.

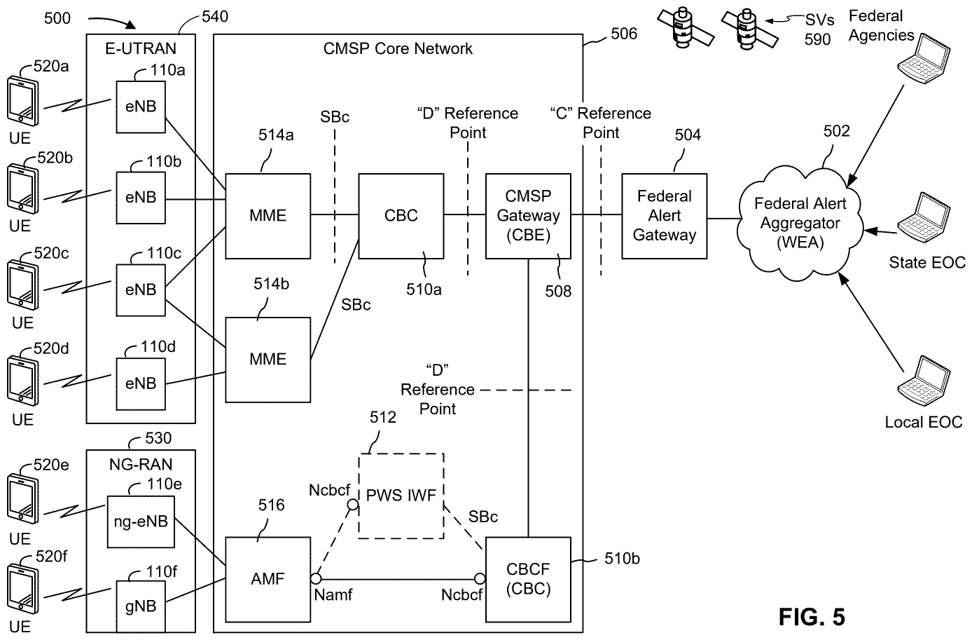

FIG. 5 is a diagram of an example 500 of a network architecture for providing wireless emergency alerts. As shown in FIG. 5, alert messages (e.g., emergency alert messages, WEA messages) originating from various sources (e.g., federal agencies, local EOCs, and state EOCs) may be provided to an alert aggregator 502 for dissemination to network providers. In an example, the alert aggregator 502 may provide the alerts to a federal alert gateway 504 configured to authenticate the alert messages to prevent fraudulent alerts from being broadcast by a WEA system.

A CMSP core network 506 may receive alerts including impact area information from the federal alert gateway 504. The CMSP core network 506 may include a CMSP gateway 508 configured to verify and reformat incoming messages and distribute the messages to one or more cell broadcast centers (CBCs). The CMSP gateway 508 may also be referred to as cell broadcast entity (CBE). A CBC 510a may be used in a 4G LTE architecture and a CBC function (CBCF) 510b may be used in a 5G (e.g., NR) architecture. The CBC 510a and the CBCF 510b (collectively referred to as CBCs 510) may be configured to retain information to identify tracking areas, emergency areas, or cell ID lists for an alert, until the alert is canceled or the alert expires. The CBCs 510 may determine network elements for a WEA alert to include in a broadcast. The CBCs 510 may pass alert messages to one or more mobility management entities (MMEs) 514a-b via an SBc interface. In one variant, the CBCF 510b may pass an alert message directly to an access and mobility management function (AMF) 516 using a service-based interface. In another example, an alert message may be transferred by CBCF 510b to a PWS interworking function (IWF) 512 using an SBc interface. The PWS IWF 512 may then perform protocol translation and transfer the alert message to AMF 516 using a service-based interface.

The CBCs 510 (e.g., CBC 510a and CBCF 510b) may decide in which cells (or in which tracking areas or emergency areas, which may map to cells) an alert message needs to be broadcast, based on the impact area. The CBCs 510 may receive a description or definition of the impact area along with the alert message and a required frequency and duration of transmission for the alert message from the CMSP gateway 508, which in turn may receive at least the description or definition of the impact area and the alert message from federal alert gateway 504. The impact area may be defined as a polygon, ellipse, circle or some other 2-dimensional (or 3-dimensional) shape or shapes. The CBCs 510 may determine the wireless cells (or possibly the tracking areas or emergency areas), for RANs attached to CMSP core network 506, which are within or at least partly within the impact area. The CBCs 510 may determine a list of cells (or tracking areas or emergency areas) and send the alert message to one or more MMEs 514a-b or one or more AMFs 516 along with the list of cells (or tracking areas or emergency areas).

In some cases, a CBC 510 may only transfer, to an MME 514 or AMF 516, a list of cells (or tracking areas or emergency areas) which can be accessed from network nodes 110 connected to or reachable from the MME 514 or AMF 516. For example, the CBC 510 may partition a complete list of cells corresponding to the target area into different non-overlapping subsets of cells, where each subset of cells is transferred to a different MME 514 or AMF 516. The CBC 510 may also transfer to each MME 514 and AMF 516 an indication of one or more tracking areas in which the alert message needs to be broadcast, which may be used by an MME 514 or AMF 516 to determine network nodes 110 (e.g., eNBs, ng-eNBs or gNBs) to which the alert message should be transferred for possible broadcast.

The MMEs 514 and AMF 516 may normally support network access and registration by UEs 520 (which may be examples of the UEs 120 described with reference to FIGS. 1 through 4), mobility of UEs 520, including cell change and handover, and may participate in supporting a signaling connection to a UE 520 and possibly data and voice bearers for a UE 520. The MMEs 514 may transfer an alert message along with a list of cells to one or more of eNBs 110a-d in an Evolved Universal Mobile Telecommunications System (UMTS) Terrestrial Radio Access (E-UTRAN) 540, as determined using the indication of the one or more tracking areas provided by CBC 510a. The AMF 516 may perform a corresponding role with respect to transferring the alert message along with a list of cells to one or more of gNBs 110f or ng-eNBs 110e in a Next Generation RAN (NG-RAN) 530, as determined using the indication of the one or more tracking areas provided by CBCF 510b. The gNB 110f may support wireless access using NR by a UE 520f, the ng-eNB 110e may support wireless access using LTE for a UE 520e (but with communication passing through AMF 516 rather than an MME 514), and the eNBs 110a-d may support wireless access using LTE by UEs 520a-d. The network nodes 110, comprising the eNBs 110a-d, ng-eNB 110e, and gNB 110f, may broadcast the alert message (e.g., using a SIB6, SIB7 or SIB8 for 5G NR or a SIB12 for LTE), including the target area shape, to UEs 520 in their respective coverage areas. The broadcast may occur in each cell that is indicated to a network node 110 in association with the alert message by an MME 514 or AMF 516.

In some cases, a network node 110 (e.g., an eNB 110a, ng-eNB 110e or gNB 110f) may broadcast an alert message to UEs 520 via a communication satellite (not shown in FIG. 5), instead of or in addition to broadcasting the alert message to UEs 520 over a terrestrial downlink. A coverage area of the communication satellite may correspond to a satellite cell. In some cases, part of or all of a network node 110 (e.g., an eNB 110a, ng-eNB 110e or gNB 110f) may be onboard (e.g., may be part of) a communication satellite and an MME 514 or AMF 516 may send an alert message to the onboard network node 110 (e.g., directly or via a portion of the network node 110 that is on the ground) for broadcast to UEs 520 over a satellite downlink.

The network architecture may be associated with or have access to space vehicles (SVs) 590 for a GNSS like GPS, Galileo, Beidou, or some other local or regional satellite positioning system (SPS). The UEs 520 may obtain location measurements for signals transmitted by SVs 590 or by network nodes 110 and access points such as eNBs 110a-d, ng-eNB 110e, or gNB 110f, which may enable a UE 520 to determine a location estimate for UE 520 or to obtain a location estimate for UE 520 from a location server in CMSP core network 506. For example, the UE 520 may transfer location measurements to the location server to compute and return the location estimate. The UEs 520 (or a location server in CMSP core network 506) may obtain a location estimate for UE 520 using position techniques such as GPS, assisted GPS (A-GPS), assisted GNSS (A-GNSS), observed time difference of arrival (OTDOA), enhanced cell ID (ECID), wireless local area network (WLAN) positioning (e.g., using signals transmitted by IEEE 802.11 WiFi access points), or sensors (e.g., inertial sensors) in the UE 520. The UE 520 may use a location estimate for the UE 520 to determine or help determine whether the UE 520 is in an impact area for a broadcast alert message.

As indicated above, FIG. 5 is provided as an example. Other examples may differ from what is described with regard to FIG. 5.

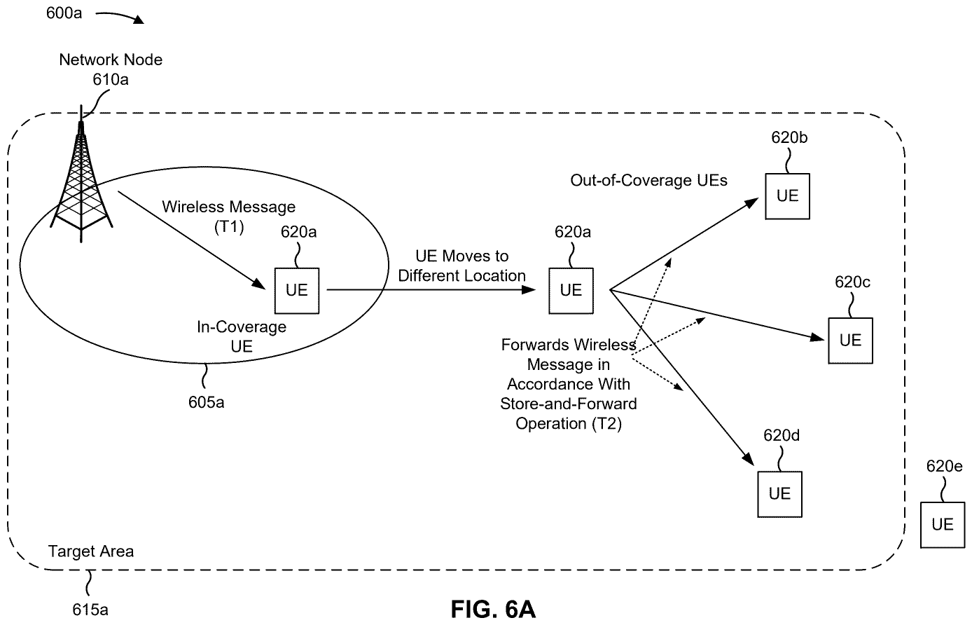

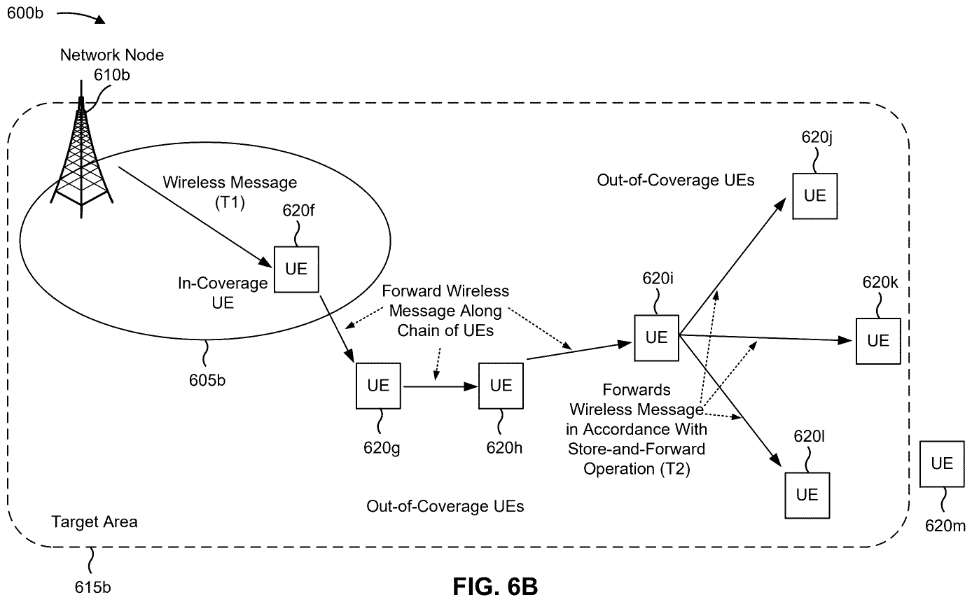

FIGS. 6A and 6B are diagrams illustrating example scenarios 600a and 600b associated with transmitting wireless messages during an alerting event. In particular, the example scenarios 600a and 600b illustrate a UE 620 performing a store-and-forward operation associated with a wireless message. In some cases, the example scenarios may include aspects described with reference to FIGS. 1 through 5. For example, the UEs 620 may be examples of or include aspects of the UEs 120 or the UEs 520 and the network nodes 610 may be examples of or include aspects of the network nodes 110.

As shown in FIG. 6A, a first UE 620a may receive a wireless message from a network node 610a, as described for the examples in FIGS. 3-5. The first UE 620a may be in-coverage with the network node 610a. That is, at a first time (T1), the first UE 620a may be within a coverage area 605a provided by the network node 610a. The network node 610a may transmit, and the first UE 620a may receive, the wireless message at the first time (T1). For example, the network node 610a may broadcast the wireless message at the first time (T1). Accordingly, any UEs 620 within the coverage area 605a provided by the network node 610a may receive the wireless message at the first time (T1). Additionally, UEs 620 that are outside of the coverage area 605a at the first time (T1) may not receive the wireless message at the first time (T1). For example, the UE 620b, the UE 620c, the UE 620d, and the UE 620e may be outside of the coverage area 605a (e.g., may be out-of-coverage UEs) and may not receive the broadcast wireless message at the first time (T1).

In some cases, to transmit the wireless message, the network node 610a may transmit a plurality of segments, where the plurality of segments correspond to the wireless message. To decode the wireless message broadcast by the network node 610a, a UE 620 (e.g., the UE 620a) may combine the plurality of segments to obtain the wireless message. For example, a receiving UE 620 may decode and store each of the plurality of segments broadcast by the network node 610a. Then, the UE 620 may combine the plurality of segments to obtain the wireless message.

The first UE 620a may be configured to perform a store-and-forward operation associated with the wireless message. Accordingly, when the first UE 620 receives the wireless message from the network node 610a (e.g., at the first time T1), the first UE 620a may store the wireless message within memory at the first UE 620a.

The first UE 620a may receive the wireless message when the first UE 620a is at a first location (e.g., within the coverage area 605a). The first UE 620a may then move from the first location to a second location (e.g., outside of the coverage area 605a). At the second location and at a second time (T2), the first UE 620a may forward the wireless message to a plurality of UEs 620 that are within a target area 615a associated with the wireless message. For example, the UE 620b, the UE 620c, and the UE 620d may be within the target area 615a of the wireless message, but out-of-coverage of the network node 610a. Accordingly, the first UE 620a may forward the wireless message to the UE 620b, the UE 620c, and the UE 620d at the second time (T2). The first UE 620a may not forward the wireless message to UEs 620 that are outside of the target area 615a associated with the wireless message. For example, the first UE 620a may not forward the wireless message to the UE 620e.

In some cases, when the first UE 620a goes out of coverage, the first UE 620a may act as a relay UE for deferred broadcast (e.g., for store-and-forward operations) and as a remote UE for wireless messages broadcast by other relay UEs. That is, when the first UE 620a moves out of coverage and is not performing a broadcast of a wireless message, the first UE 620a may listen for and receive wireless messages broadcast by other relay UEs. The first UE 620a may then replace older versions of a wireless message by any newer versions of the wireless message (e.g., messages that have the same message identifier and same message code) received from other relay UEs. Then, the first UE 620a may include the newer versions of the wireless message in its own broadcast of the wireless message. Additionally, the first UE 620a may store wireless messages received from other relay UEs that have no counterparts stored in the first UE 620a (e.g., with the same message identifier and same message code) and includes these, if allowed, in its own broadcast.

As indicated above, FIG. 6A is provided as an example. Other examples may differ from what is described with regard to FIG. 6A.

In FIG. 6A, the wireless message is transferred to other UEs 620 (e.g., the UE 620b, the UE 620c, and the UE 620d) partly through the movement of the first UE 620a. If the first UE 620a did not move, then the wireless message transfer to the second UE 620b, the third UE 620c, and the fourth UE 620d might not be possible due to distances between the first UE 620a and each of the other UEs 620 that exceed a maximum distance for sidelink signaling. The method of transfer shown in FIG. 6A can thus involve diffusion of UEs 620 that have received the wireless message into other parts of a target area 615a where they are then able to transfer the wireless message to other UEs 620.

In FIG. 6B, in contrast to FIG. 6A, the UEs 620 do not move prior to transferring the wireless message. As shown in FIG. 6B, a first UE 620f may receive a wireless message from a network node 610b, as described for the examples in FIGS. 3-5. The first UE 620f may be in-coverage with the network node 610b. That is, the first UE 620f may be within the coverage area 605b provided by the network node 610b. The first UE 620f may receive the wireless message at a first time (T1). The first UE 620f may receive the wireless message when the first UE 620f is at a first location. The first UE 620f may remain at or near to the first location. At a second time (T2), the first UE 620f may forward the wireless message to a second UE 620g that is at a second location within the target area 615b. The second UE 620g may remain at or near to the second location. At a third time (T3), the second UE 620g may forward the wireless message to a third UE 620h that is at a third location within the target area 615b. The third UE 620h may remain at or near to the third location. At a fourth time (T4), the third UE 620h may forward the wireless message to a fourth UE 620i that is at a fourth location within the target area 615b. The fourth UE 620i may remain at or near to the fourth location. At a fifth time (T5), the fourth UE 620i may forward the wireless message to a plurality of UEs 620 that are within the target area, which may include a fifth UE 620j, a sixth UE 620k, and a seventh UE 620l. The second, third, fourth, fifth, sixth and seventh UEs 620 may be out-of-coverage with the network node 610b (e.g., outside of the coverage area 605b provided by the network node 610b) but still within the target area 615b. The forwarding of the wireless message from the first UE 620f to the second UE 620g, from the second UE 620g to the third UE 620h, from the third UE 620h to the fourth UE 620i, and from the fourth UE 620i to the fifth UE 620j and the sixth UE 620k and the seventh UE 620l may be in accordance with a store-and-forward operation. The fourth UE 620i may not forward the wireless message to an eighth UE 620m, which may be outside of the target area 615b.

As indicated above, FIG. 6B is provided as an example. Other examples may differ from what is described with regard to FIG. 6B.

In FIG. 6B, the wireless message is transferred to other UEs 620 by means of transfer along a chain of UEs 620, where UEs 620 involved in the transfer do not necessarily move. The method of transfer shown in FIG. 6B can thus involve diffusion of the wireless message into other parts of a target area 615b rather than diffusion of UEs 620 that carry the wireless message as in FIG. 6A. The method of transfer shown in FIG. 6B may be faster than the method shown in FIG. 6A because transfer of a wireless message can occur without any delay for movement of a UE 620, For example, if each UE 620 that receives a wireless message (e.g., from a network node 610 or from another UE 620) is able to transfer the wireless message using store-and-forward operations to other UEs 620 nearby to the UE 620 in a few seconds, it could be possible to transfer the wireless message to most or all UEs 620 in a target area 615b that are out of coverage of network nodes 610 in less than a minute or in a few minutes. In some scenarios, transfer of a wireless message to UEs 620 in a target area 615 may include transfer as in FIG. 6A and transfer as in FIG. 6B.

It is noted that transfer of a wireless message along a chain of UEs 620 using store-and-forward operation, as exemplified in FIG. 6B, can differ from real time transfer of a wireless message along a chain of UEs 620. With transfer of a wireless messages along a chain of UEs 620 in real time, sidelink connections or links between pairs of UEs 620 in the chain of UEs 620 may need to be established prior to transfer of a wireless message. After the sidelink connections or links are established, a second UE 620 that receives a wireless message from a first UE 620 using a first sidelink connection can immediately send the wireless message to a third UE using a second sidelink connection that is contemporaneous with the first sidelink connection. This method of transfer could be used (e.g., in FIG. 6B) if pairs of UEs 620 first establish contemporaneous sidelink connections (e.g., with a separate sidelink connection between the first UE 620f and the second UE 620g, the second UE 620g and the third UE 620h, the third UE 620h and the fourth UE 620i, and the fourth UE 620i and the fifth UE 620j, the sixth UE 620k, the seventh UE 620l in the case of FIG. 6B).

In some implementations, sidelink connections or links between pairs of UEs 620 in a chain of UEs 620 may not be used to transfer a wireless message along a chain of UEs 620 in real time. Instead, each UE 620 in a chain of UEs 620 may receive a wireless message broadcast by an upstream UE 620 or network node 610 and then broadcast (e.g., immediately) the wireless message to one or more downstream UEs 620. Such a transfer of a wireless message along a chain of UEs 620 in real time (e.g., and with or without sidelink connections or links between pairs of UEs 620) may be similar to the store and forward transfer operations as described with reference to FIG. 6B. However, such real-time transfer (also referred to as an immediate transfer) of a wireless message along a chain of UEs may be dependent upon simultaneous or almost simultaneous transmission and reception of the wireless message among all the UEs 620. That is, this real-time transfer may not be successful when one or more UEs 620 are not within sidelink range of any of the other UEs 620 or are not able to transmit or receive the wireless message for other reasons at a time when a broadcast or transmission of the wireless message occurs. But using store and forward operation to broadcast or transmit a wireless message to UEs 620 in a target area 615 (e.g., as described above with reference to FIGS. 6A and 6B) may not be associated with a similar limitation because the broadcast or transmission may not take place at a single time.

It is further noted that the method of wireless transfer illustrated in FIG. 6B may be associated with (e.g. may require) a higher density of UEs 620 in a target area 615 as compared to the method illustrated in FIG. 6A, as each UE 620 may be (e.g. may need to be) near enough to one or more other UEs 620 to allow sidelink transfer of the wireless message without significant movement by any of the UEs 620.

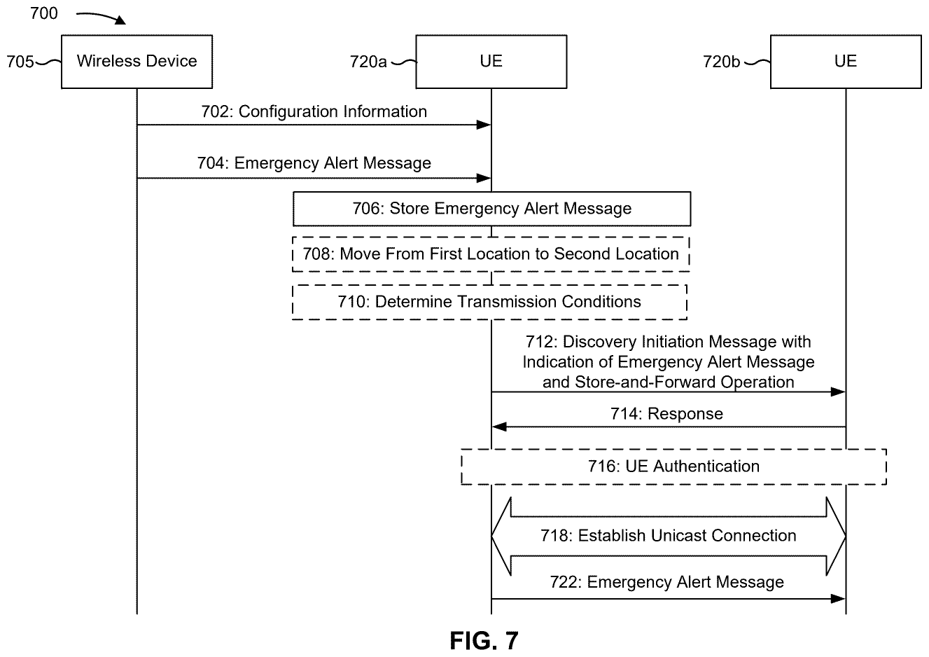

FIG. 7 is a diagram illustrating an example 700 associated with transmitting emergency alert messages during an alerting event. As shown in FIG. 7, example 700 includes communication between a wireless device 705, a first UE (e.g., UE 720a), and a second UE (e.g., UE 720b). In some aspects, the wireless device 705, the first UE 720a, and the second UE 720b may be included in a wireless network, such as wireless network 100. The wireless device 705 may be a network node (e.g., a network node 110 or a network node 610, as described herein) or may be a UE (e.g., a UE 120 or UE 620). Additionally, the UEs 720 may be examples of or include aspects of the UEs described with reference to FIGS. 1 through 6.

As shown by reference number 702, the first UE 720a may receive, from the wireless device 705, configuration information for store-and-forward operations. In some other examples, the first UE 720a may receive the configuration information from another wireless device 705 that is associated with a serving PLMN or home PLMN (HPLMN) for the UE 720a. The configuration information may correspond to configuration information that is preconfigured by a serving PLMN or HPLMN associated with the first UE 720a. The configuration information may indicate, to the first UE 720a, one or more parameters or configurations associated with the first UE 720a performing or otherwise communicating wireless messages (e.g., emergency alert messages) to one or more other UEs via a sidelink. In the example 700, the configuration information may authorize the first UE 720a to perform PWS deferred relaying (e.g., using store-and-forward operations).

In the example 700, the configuration information may indicate that the first UE 720a is allowed to transmit emergency alert messages in accordance with a store-and-forward operation. That is, the configuration information may include a flag, where a first value of the flag indicates that the first UE 720a is allowed to transmit emergency alert messages in accordance with store-and-forward operations and a second value of the flag indicates that the first UE 720a is not allowed to transmit emergency alert messages in accordance with store-and-forward operations. In the example 700, the flag may be set to the first value indicating that the first UE 720a is allowed to transmit emergency alert messages in accordance with store-and-forward operations.

If the configuration information indicates that the first UE 720a is allowed to transmit emergency alert messages in accordance with store-and-forward operations, the configuration information may indicate a type of geographic area, referred to here as a “relay geographic area type”, associated with the first UE 720a transmitting (e.g., relaying) emergency alert messages. For example, the relay geographic area type may indicate whether the first UE 720a must be within the target area associated with the emergency alert message to perform the relaying of the emergency alert message according to the store-and-forward operation or if the first UE 720a may be within an extended area that is based on the target area. For example, the relay geographic area type may indicate that the first UE 720a may relay the emergency alert message according to the store-and-forward operation if the first UE 720a is within a shape that is extended beyond the target area by a distance ‘D’ (e.g., within a circle or polygon that is extended beyond the target area by the distance ‘D’). Additionally, the configuration information may indicate a maximum number of hops for the store-and-forward operations.

Additionally, the configuration information may indicate, to the first UE 720a, whether the first UE 720a is allowed to transmit emergency alert messages in accordance with immediate broadcast operations. For example, the configuration information may include a flag, where a first value of the flag indicates that the first UE 720a is allowed to transmit emergency alert messages in accordance with immediate broadcast operations and a second value of the flag indicates that the first UE 720a is not allowed to transmit emergency alert messages in accordance with immediate broadcast operations. If the configuration information indicates that the first UE 720a is allowed to transmit emergency alert messages in accordance with immediate broadcast operations, the configuration information may indicate a type of geographic area associated with the first UE 720a transmitting emergency alert messages. For example, the configuration information may additionally indicate whether the first UE 720a must be within the target area associated with the emergency alert message to perform the relaying of the emergency alert message according to the immediate broadcast operation.

The configuration information may additionally indicate one or more identifiers of emergency alert messages that the first UE 720a is allowed to transmit according to immediate broadcast operations or according to store-and-forward operations. The identifiers may correspond to WEA Message identifiers.

Additionally, the configuration information may indicate one or more source devices for emergency alert messages that the first UE 720a is allowed to transmit with store-and-forward operations. For example, the configuration information may indicate whether the first UE 720a is allowed to relay emergency alert messages (e.g., via immediate broadcast operations or via store-and-forward operations) for the HPLMN, other PLMNs of the home country of the HPLMN, or other specific PLMNs. In another example, the configuration information may indicate whether the first UE 720a is allowed to relay emergency alert messages (e.g., in accordance with immediate broadcast operations or in accordance with store-and-forward operations) that are received from another relay UE, where the source of the emergency alert message is the HPLMN, other PLMNs of the home country of the HPLMN, or other specific PLMNs.

The configuration information may indicate a maximum duration between the first UE 720a receiving an emergency alert message and no longer transmitting the emergency alert message. In one example, the maximum duration may correspond to a time from the receipt of the emergency alert message from the source PLMN (e.g., if the first UE 720a is aware of the time that the emergency alert message is received from the source PLMN) to the time when the first UE 720a is no longer configured to transmit the emergency alert message. In another example (e.g., where the first UE 720a is not aware of the time of receipt of the emergency alert message from the source PLMN), the maximum duration may correspond to a maximum time between the first UE 720a receiving the emergency alert message from another UE (e.g., the wireless device 705) and no longer transmitting the emergency alert message. It is noted that before the maximum duration has expired, the first UE 720a may transmit the emergency alert message one or more times, but after the maximum duration has expired, the first UE 720a may not (e.g. does not) transmit the emergency alert message.

The configuration information may indicate a periodicity of the first UE 720a initiating transfer of an emergency alert message two or more times. For example, the periodicity may indicate a minimum time period, a maximum time period or both between consecutive transmissions of a Discovery Initiation message as described with reference to 712.

As shown by reference number 704, the first UE 720a may receive, from the wireless device 705, an emergency alert message that indicates an alerting event. The alerting event may involve a natural disaster, a man-made disaster, or a loss of coverage to a wireless network. The emergency alert message may be a WEA message. The first UE 720a may receive the emergency alert message at a first time (T1) and at a first location. The first UE 720a may receive the emergency alert message from the wireless device 705 via a broadcast when the first UE 720a is in-coverage with the wireless device 705 (e.g., as described for FIGS. 3-6). The first UE 720a may receive the emergency alert message from a network node (e.g., the wireless device 705) or from a third UE (e.g., the wireless device 705) via a sidelink interface, where the third UE may have received the emergency alert message from a network node or from another UE via a sidelink interface.

In some aspects, the wireless network may receive a message indicating a disaster event from a government entity or some other entity (e.g., as described in FIGS. 3 to 5). The message may be sent to various entities before being transmitted to the wireless network (e.g., as described in FIG. 5), which may then forward a corresponding emergency alert message to the first UE 720a.

In some aspects, the emergency alert message received at 704 may be associated with (e.g., may include) configuration information associated with the first UE 720a relaying (or not relaying) the emergency alert message. That is, while the first UE 720a may receive the configuration information from an HPLMN or from a serving PLMN, as shown by reference number 702, the emergency alert message may include an extension that includes additional (or alternate) configuration information. Alternatively, the first UE 720a may not receive any configuration information at 702, and may instead receive the configuration information with the emergency alert message at 704.

The configuration information received with the emergency alert message may indicate one or more of: whether the first UE 720a is allowed to transmit the emergency alert message in accordance with an immediate broadcast operation, whether the first UE 720a is allowed to transmit the emergency alert message in accordance with the store-and-forward operation, one or more source devices for emergency alert messages that the first UE 720a is allowed to transmit with store-and-forward operations, a type of the first UE 720a allowed to transmit emergency alert messages with store-and-forward operations, an indication of a maximum duration between the first UE 720a receiving the emergency alert message and no longer transmitting the emergency alert message during the store-and-forward operation, an indication of a geographic area (e.g., a relay geographic area type) associated with transmitting the emergency alert message in accordance with the store-and-forward operation, an indication of a maximum number of hops for the store-and-forward operations, or a periodicity (e.g., a maximum time period or a minimum time period) of consecutive broadcast transmissions of a Discovery Initiation message in accordance with the store-and-forward operation.

If the configuration information within the emergency alert message conflicts with configuration information received from the serving PLMN, HPLMN or other PLMN (e.g., that is configured at 702), the first UE 720a may proceed according to the configuration information received with the emergency alert message.

As an example, the emergency alert message may be associated with an indication (e.g., an indication in a relay geographic area type) for the first UE 720a to convey the emergency alert message to other UEs in a target area. The target area may be a target WEA area. The indication and the emergency alert message may be included in a SIB transmitted by the wireless device 705 via a broadcast or in a sidelink communication from a third UE. The first UE 720a may be within the target area when the emergency alert message is received, or alternatively, the first UE 720a may be outside the target area when the emergency alert message is received. In some aspects, the indication associated with the emergency alert message may be a flag or other parameter that indicates that the first UE 720a is to convey the emergency alert message to other UEs and may further indicate a method or methods by which the conveyance to other UEs is to be supported. For example, when the indication is a flag and when the flag is set to “ON,” the first UE 720a may be configured to automatically convey the emergency alert message to other UEs in the target area using a particular predefined or preconfigured method.

In an aspect, the wireless device 705 may include the indication in, or with, the emergency alert message transmitted by the wireless device 705 at 704, for the first UE 720a to convey the emergency alert message to other UEs in the target area when an operator for the wireless device 705 may not be able to broadcast the emergency alert message throughout all of the target area. For example, the alerting event for the emergency alert message may correspond to a disaster event (e.g., a hurricane, tornado, tsunami or wildfire) in which some network nodes for the operator of the wireless device 705 may have been damaged or otherwise rendered inoperable by the disaster event. Some of the damaged or inoperable network nodes may be needed to broadcast the emergency alert message throughout all of the target area, but may be unable to do so. The operator may then configure the wireless device 705 or another element or elements (e.g., a CBC, AMF or MME) in a network for the operator to include the indication in, or with, the emergency alert message that UEs that receive the emergency alert message (e.g., the first UE 720a) are to convey the emergency alert message to other UEs in the target area (e.g., the second UE 720b). In these conditions, the wireless device 705 may also include authentication information in the emergency alert message or sent in association with the emergency alert message at 704, as described later herein.

In some cases, to transmit the emergency alert message, the wireless device 705 may divide the emergency alert message into a plurality of segments and transmit, to the first UE 720a, each of the plurality of segments that correspond to the emergency alert message. Each segment, of the plurality of segments, may include a message segment field or information element (e.g., that carries a portion of the emergency alert message) and an indication of a segment number associated with the portion of the emergency alert message. The first UE 720a may then reassemble the emergency alert message by combining the plurality of segments. That is, to reassemble the emergency alert message, the first UE 720a may decode and then combine the portions of the emergency alert message (e.g., each received within one of the plurality of segments) according to an order of the segment numbers associated with each portion of the emergency alert message.

As shown by reference number 706, the first UE 720a may store the emergency alert message in a memory of the first UE 720a. The first UE 720a may store the emergency alert message in the memory of the first UE 720a after decoding and reassembling the emergency alert message. Accordingly, the stored emergency alert message may correspond to a reassembled emergency alert message that includes a plurality of segments of the emergency alert message received from the wireless device 705.

The first UE 720a may store the emergency alert message for a certain period of time (e.g., a validity time), after which the first UE 720a may erase the emergency alert message from the memory of the first UE 720a. The period of time may correspond to an expected duration of the alerting event, an expected duration of a warning for the alerting event, or a validity time for the emergency alert message, and may be received at 702 in association with the configuration information. Alternatively, the period of time may be received at 704 in association with the emergency alert message or may be preconfigured in the first UE 720a by the configuration information received at 702. A validity time may comprise a time, a date or a date and time after which information in the emergency alert message is no longer valid or (fully) trustworthy. Additionally, or alternatively, the validity time may correspond to a configured maximum duration between the first UE 720a receiving the emergency alert message and no longer transmitting the emergency alert message using store-and-forward operations.

The first UE 720a may store the emergency alert message regardless of whether the first UE 720a is in the target area or outside of the target area. The first UE 720a may display the emergency alert message to a user of the first UE 720a when the first UE 720a is within the target area or is uncertain of being within the target area (e.g., when the first UE 720a is unaware of whether the first UE 720a is within the target area or outside of the target area), or the first UE 720a may not display the emergency alert message to the user when the first UE 720a is outside of the target area.

As shown by reference number 708, the first UE 720a may move from the first location to a second location. In other words, the first UE 720a may be a mobile UE, and after receiving the emergency alert message at the first location, the first UE 720a may move to the second location. The second location may be different from the first location. The second location may be outside of a coverage area of the wireless device 705 (e.g., there is no wireless network coverage at the second location). In some aspects, the first UE 720a may remain at or near to the first location and 708 may not occur.

As shown by reference number 710, the first UE 720a may determine one or more transmission conditions associated with the first UE 720a transmitting the emergency alert message using a store-and-forward operation (e.g., as described below with reference to 712, 714, 716, 718, and 722). For example, the transmission conditions may correspond to one or more conditions that allow or require the first UE 720a to transmit the emergency alert message using store-and-forward operations. The transmission conditions may include one or more of: (i) a configuration of first UE 720a (e.g., at 702 or 704) to transmit the emergency alert message according to store-and-forward operations; (ii) a determination by the first UE 720a that the first UE 720a is or may be within a particular geographic area (e.g., a target area for the emergency alert message or a geographic area defined or indicated by a relay geographic area type that was configured at 702 or 704 in the first UE 720a); (iii) a determination by the first UE 720a that a periodic time has occurred for transmitting the emergency alert message (e.g., a periodic time defined by a periodicity configured in the first UE 720a at 702 or 704); (iv) a determination by the first UE 720a that the first UE 720a is not within network coverage (e.g., the first UE 720a is not in coverage of the wireless device 705 if the wireless device 705 is a network node and the first UE 720a is not in coverage of any other network node); or (v) a determination by the first UE 720a that a maximum duration for transmitting the emergency alert message using store-and-forward operations or a validity period for the emergency alert message (e.g., as configured or received at 702 or 704) has not yet expired.

To determine the condition (ii) above, the first UE 720a may determine a location of the first UE 720a (e.g., using a location method such as GNSS or WLAN). To determine condition (iv) above, the first UE 720a may scan for network coverage across different radio frequencies and different bands and for different RATs. In some examples, the first UE 720a may transmit the emergency alert message (e.g., as described with reference to 712, 714, 716, 718, and 722) when the first UE 720a determines that all of the conditions (e.g., as in (i) to (v) above) are satisfied (e.g., determined to be true). Here, the first UE 720a may refrain from transmitting the emergency alert message (e.g., as described with reference to 712, 714, 716, 718, and 722) if the first UE 720a determines that any of the conditions (e.g., as in (i) to (v) above) are not satisfied (e.g., determined to be false). In some other examples, the first UE 720a may transmit the emergency alert message (e.g., as described with reference to 712, 714, 716, 718, and 722) if the UE 720a determines that all or some of the conditions (e.g., as in (i) to (v) above) are satisfied (e.g., determined to be true). Here, the first UE 720a may refrain from transmitting the emergency alert message (e.g., as described with reference to 712, 714, 716, 718, and 722) when the first UE 720a determines certain of these conditions (e.g., as in (i) to (v) above) are not satisfied (e.g., determined to be false).

When the first UE 720a determines to transmit the emergency alert message (e.g., as described with reference to 710), then, and as shown by reference number 712, the first UE 720a may broadcast or transmit, to a second UE 720b, a discovery initiation message. The discovery initiation message may include an indication of both the emergency alert message and the store-and-forward operation associated with the emergency alert message. For example, the discovery initiation message may include a relay service code that indicates that the emergency alert message is associated with the store-and-forward operation (e.g., the relay service code may indicate a deferred emergency alert message “Push”). In some cases, the discovery initiation message may indicate that a purpose of the discovery initiation message is to forward the emergency alert message. It is noted that the first UE 720a may not be aware of the second UE 720b initially (e.g., at the first time) and thus may broadcast the discovery initiation message to all UEs that may be nearby to the first UE 720a, where the discovery initiation message is received by the second UE 720b. In some cases, the discovery initiation message may correspond to a ProSe PC5 discovery message.

By transmitting the discovery initiation message, the first UE 720a may advertise that the first UE 720a has the emergency alert message (or has an emergency alert message concerning an alerting event) and is able to forward the emergency alert message in accordance with the store-and-forward operation. The first UE 720a may transmit the discovery initiation message based at least in part on the configuration information associated with the emergency alert message. The first UE 720a may transmit the discovery initiation message at a second time (T2) and may transmit the discovery initiation message after moving to the second location if 708 has occurred. In other words, the first UE 720a may attempt to discover UEs that have not yet received the emergency alert message and that may be nearby to the first location or nearby to the second location if 708 occurs.

The second UE 720b may be out-of-coverage with the wireless device 705, but the second UE 720b may still be within the target area. In this case, the target area may not be entirely within a coverage area of the wireless device 705 and may extend beyond the coverage area of the wireless device 705. The first UE 720a may include, in the transmission of the discovery initiation message, an indication or indications of characteristics of the emergency alert message, such as: a type of emergency alert message; a type of alerting event; an emergency alert message identifier or serial number; a target area for the emergency alert message; or an age of the emergency alert message, which may be a time interval since the first UE 720a received the emergency alert message at 704 (e.g., a time T2−T1) or a time interval since the emergency alert message was originally received from a PLMN by a previous UE at a time T0 (e.g., a time T2−T0). These characteristics of the emergency alert message may assist the second UE 720b in deciding whether to receive the emergency alert message from the first UE 720a as described below. Additionally, the discovery initiation message may include an indication or indications of a quantity of emergency alert messages stored at the first UE 720a, an indication of a quantity of hops between a source device of the emergency alert message and the first UE 720a, or an identifier associated with a source device of the emergency alert message.

It is noted that an age of the emergency alert message may indicate a time interval since the emergency alert message was received by any UE from a wireless device 705. For example, if the first UE 720a receives the emergency alert message at 704 from the third UE (e.g., the wireless device 705 corresponds to a third UE 720) rather than from the a network node, and if the third UE received the emergency alert message from a network node at a third time T3 (where T3 occurs before T1), then the time interval included at 712 by the first UE 720a may be the time since the third time (e.g., T2−T3). For example, the first UE 720a may receive an age T1−T3 of the emergency alert message from the third UE along with the emergency alert message and may increase the age by the extra message time at the first UE 720a (T2−T1) resulting in an age T2-T3 which may be indicated by the first UE 720a at 708.

As shown by reference number 714, the first UE 720a may receive, from the second UE 720b, a response to the discovery initiation message. The response may indicate that the second UE 720b has not yet received the emergency alert message, may not yet have received the emergency alert message (e.g., due to being out of network coverage), or simply that the second UE 720b requests the first UE 720a to transfer the emergency alert message. Alternatively, the response itself may be an indication that the second UE 720b has not, or may not yet have, received the emergency alert message. When the second UE 720b has already received the emergency alert message or decides (e.g., based on the indication or indications of characteristics of the emergency alert message received at 712) not to receive the emergency alert message, the second UE 720b may not transmit the response to the first UE 720a. For example, the second UE 720b may decide not to receive the emergency alert message if a type of alerting event indicated at 712 does not correspond to a disaster event, if the second UE 720b has already received an emergency alert message with the same message identifier or serial number as indicated at 712, if the second UE 720b is not in or not near to a target area for the emergency alert message, or if an age of the emergency alert message indicated at 712 exceeds a preconfigured threshold. Conversely, the second UE 720b may decide to receive the emergency alert message if none of the previous conditions are indicated and may then send the response at 714.

As shown by reference number 716, the second UE 720b may authenticate the first UE 720a. The authentication may be based on a Rivest-Shamir-Adleman (RSA) private key-public key pair, an elliptic curve private key-public key pair, or a Transport Layer Security (TLS) protocol. During the authentication, the first UE 720a may send, to the second UE 720b, authentication information associated with the first UE 720a. The authentication information associated with the first UE 720a may include a public key certificate for the first UE 720a (e.g., an international telecommunication union (ITU) defined key certificate). The second UE 720b may use the authentication information associated with the first UE 720a (e.g., the public key certificate for the first UE 720a) to authenticate the first UE 720a (e.g., to authenticate an identity of the first UE 720a). A successful authentication of the first UE 702a may enable a higher level of trust in the first UE 720a by the second UE 720b. Additionally, or alternatively, a successful authentication of the first UE 720a may enable the second UE 720b to receive the emergency alert message from the first UE 720a (e.g., the second UE 720b may not be configured to receive emergency alert messages from any UEs with which the second UE 720b is unable to perform a successful authentication). In some cases, the authentication at 716 may occur partly during discovery (e.g., at 712 and 714) or partly or wholly during a unicast connection establishment (e.g., at 718). In some cases, the authentication at 716 may not occur.

As shown by reference number 718, the first UE 720a and the second UE 720b may establish a unicast connection. For example, the UE 720 and the UE 720b may establish a ProSe direct link using sidelink signaling. In some cases, the unicast connection may correspond to a sidelink RRC connection between the first UE 720a and the second UE 720b.

As shown by reference number 722, the first UE 720a may transmit, to the second UE 720b, the emergency alert message in accordance with a store-and-forward operation and in response to the response at 714. The first UE 720a may transmit the emergency alert message via the unicast connection established at 718.

In some aspects, the first UE 720a may transmit the emergency alert message to the second UE 720b when the second UE 720b is, or may be, in or near to the target area for the emergency alert message if the first UE 720a can determine this. For example, the first UE 720a may know its own location (e.g., which may be determined by the first UE 720a using GPS, GNSS, WLAN or other methods) and may know an approximate or maximum distance from the first UE 720a to the second UE 720b, which may enable the first UE 720a to determine an area within which the second UE 720b is located. If at least a portion of this area is within the target area or close to the target area, the first UE 720a may proceed with the operation at 718.

In some cases, the first UE 720a may transmit the emergency alert message to the second UE 720b without re-segmenting the emergency alert message. That is, the first UE 720a may transmit the reassembled emergency alert message to the second UE 720b at 722. In some other cases, the first UE 720a may re-segment the emergency alert message prior to transmitting the emergency alert message to the UE 720b. For example, the first UE 720a may divide the emergency alert message into a plurality of segments, and transmit the plurality of segments to the second UE 720b via the unicast link. The size of each segment included in the unicast transmission from the first UE 720a at 722 may be the same as or different from the size of each segment of the emergency alert message received from the wireless device 705 at 704.

The operations at 712, 714, 716, 718, and 722 may be referred to as a “Push” method for transferring the emergency alert message because a UE that has received the emergency alert message (in this case the first UE 720a) instigates transfer of the emergency alert message to a UE that has not yet received the emergency alert message (in this case the second UE 720b). The messages transferred at each of the operations at 712, 714, 716, 718, and 722 may be ProSe messages in one aspect. The first UE 720a may perform the “Push” method at 712, 714, 716, 718, and 722 when the first UE 720a receives the indication (e.g., at 702 or 704) for the first UE 720a to convey the emergency alert message to other UEs in a target area. For example, the indication may be a flag and the first UE 720a may perform the operations at 712, 714, 716, 718, and 722 when the flag is set to ON. Alternatively, the first UE 720a may perform the operations at 712, 714, 716, 718, and 722 when the first UE 720a receives an indication to use a “Push” method to convey the emergency alert message to other UEs in a target area. The first UE 720a may not transmit the emergency alert message to UEs that are known to be outside of the target area. The first UE 720a may verify that the second UE 720b is within (or close to) the target area before transmitting the emergency alert message, which may be based at least in part on an interaction between the first UE 720a and the second UE 720b. The first UE 720a may transmit the emergency alert message at the second time (T2), which may occur after the first time. The first UE 720a may transmit the emergency alert message via the sidelink interface. The first UE 720a may transmit the emergency alert message at the second location. Further, the first UE 720a may include configuration information received at 704 (e.g., associated with the first UE 720a relaying or not relaying the emergency alert message) with the emergency alert message transmitted to the second UE 720b at 722, which may enable the second UE 720b to further propagate the emergency alert message to other UEs in the target area.

In some aspects, the store-and-forward operation may be associated with a validity time for the emergency alert message that may be received at 704 along with the emergency alert message or as part of the emergency alert message. The first UE 720a may send the validity time along with emergency alert message to the second UE 720b at 722. The first UE 720a may stop forwarding the emergency alert message after an expiry of the validity time. In some aspects, the first UE 720a may receive the emergency alert message from the wireless device 705 (or third UE) using a certain RAT (e.g., 5G NR or LTE) and may transmit the emergency alert message to the second UE 720b using a same RAT. Alternatively, the first UE 720a may receive the emergency alert message from the wireless device 705 (or third UE) using a certain RAT and may transmit the emergency alert message to the second UE 720b using a different RAT. For example, the first UE 720a may receive the emergency alert message from the wireless device 705 at 702 using a 4G or 5G satellite RAT and may transmit the emergency alert message to the second UE 720b at 722 using a 4G or 5G terrestrial RAT.

In some aspects, a WEA message transfer using sidelink signaling may be enhanced by using the store-and-forward operation. A WEA message that is received by the first UE 720a over any RAT and from any PLMN at the first time may be later forwarded at the second time and over a possibly different RAT to another UE, such as the second UE 720b. The store-and-forward operation may be associated with a UE diffusion property, such that some proportion of UEs that receive the WEA message in real-time using an active backhaul from the base station or from another UE may, over a period of time referred to as a UE diffusion time, diffuse over much or all of the target WEA area, thereby enabling all or most UEs in the target WEA area (that support a store-and-forward capability) to receive the WEA message. The UE diffusion time may range from minutes to hours depending on the extent of the backhaul outage and the size of the target WEA area. The UE diffusion time may also depend on WEA messages that do not cause UEs (or users of UEs) to immediately stay out of the target area. With these conditions, a store-and-forward transfer using sidelink signaling may be able to at least partly overcome wireless coverage that is partly or entirely unavailable in the target WEA area.

The store-and-forward operation may also be associated with a message diffusion property, such that a WEA message may diffuse, over a period of time referred to as a message diffusion time, over much or all of the target WEA area by being passed along a chain of UEs, or along a number of chains of UEs, thereby enabling all or most UEs in the target WEA area (that support a store-and-forward capability) to receive the WEA message. Here, the UEs may not move or may move by only short distances during the message diffusion time. The message diffusion time may range from less than a minute to a few minutes depending on an extent of a backhaul outage, a size of the target WEA area and a density of UEs in the target WEA area.

In some aspects, the WEA message transfer may avoid processing and signaling impacts to UEs. The WEA message transfer may avoid forwarding WEA messages during times when WEA message forwarding is not needed (e.g., when wireless coverage is not disabled). For example, the emergency alert message received by the first UE 720a at 704 may not then be associated with an indication for the first UE 720a to convey the emergency alert message to other UEs in a target area using store-and-forward operations, which may cause the first UE 720a to not perform the operations at 712, 714, 716, 718, and 722. The WEA message transfer may maximize WEA message forwarding using sidelink store-and-forward operations when the wireless coverage is disabled, for example as described for FIGS. 6A and 6B. The wireless device 705 broadcasting the WEA message may optionally include the indication, where the indication may indicate that UE assistance (in the form of the sidelink store-and-forward operation) is needed to further convey the WEA message to other UEs in the target WEA area. The indication may be a single bit or single parameter in the WEA broadcast channel (e.g., SIB), a bit or parameter inside the WEA message, or a new type of WEA message. UEs that receive the indication may then actively attempt to forward the WEA message to other UEs without wireless coverage and that have not yet received the WEA message. For example, a UE with a WEA message may initiate discovery of other UEs and indicate in a discovery initiation that a purpose is to forward the WEA message (or messages) (e.g., as in the “Push” method shown in FIG. 7).

In some aspects, messages such as non-WEA messages (e.g., for an alerting event that is not a disaster event) may be conveyed to UEs that are out-of-coverage with the wireless device 705, similar to WEA messages. Such messages may include public safety (PS) messages, which may be transferred to all PS UEs via PS UEs that initially have wireless coverage with the wireless device 705. Such messages may include notifications to UEs in a closed group (e.g., UEs belonging to employees of a company or organization), where such notifications may be transferred to all UEs in the closed group via UEs with initial coverage. Such messages may indicate where wireless coverage is available, and the messages may be transmitted to all UE subscribers of a PLMN via other UEs of the PLMN when a PLMN experiences loss of coverage over some of its coverage area.

As indicated above, FIG. 7 is provided as an example. Other examples may differ from what is described with regard to FIG. 7.

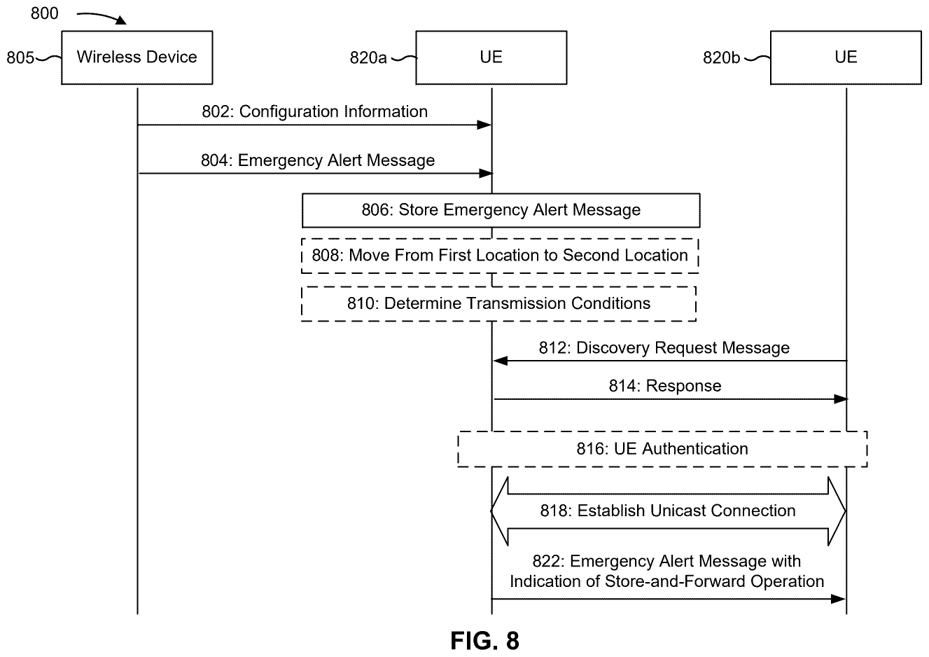

FIG. 8 is a diagram illustrating an example 800 associated with transmitting emergency alert messages during an alerting event. As shown in FIG. 8, example 800 includes communication between a wireless device 805, a first UE (e.g., UE 820a), and a second UE (e.g., UE 820b). In some aspects, the wireless device 805, the first UE 820a, and the second UE 820b may be included in a wireless network, such as wireless network 100. The wireless device 805 may be a network node (e.g., a network node 110 or a network node 610, as described herein) or may be a UE (e.g., a UE 120). Additionally, the UEs 820 may be examples of or include aspects of the UEs described with reference to FIGS. 1 through 7.

As shown by reference number 802, the first UE 820a may receive, from the wireless device 805, configuration information for store-and-forward operations. In some other examples, the first UE 820a may receive the configuration information from another wireless device that is associated with a serving PLMN or HPLMN. The configuration information may correspond to configuration information that is preconfigured by an HPLMN or serving PLMN associated with the first UE 820a. The configuration information may indicate, to the first UE 820a, one or more parameters or configurations associated with the first UE 820a performing store-and-forward operations or otherwise communicating wireless messages (e.g., emergency alert messages) to one or more other UEs via a sidelink. In the example 800, the configuration information may authorize the first UE 820a to perform PWS deferred relaying.

In the example 800, the configuration information may indicate that the first UE 820a is allowed to transmit emergency alert messages in accordance with a store-and-forward operation. That is, the configuration information may include a flag, where a first value of the flag indicates that the first UE 820a is allowed to transmit emergency alert messages in accordance with store-and-forward operations and a second value of the flag indicates that the first UE 820a is not allowed to transmit emergency alert messages in accordance with store-and-forward operations. In the example 800, the flag may be set to the first value indicating that the first UE 820a is allowed to transmit emergency alert messages in accordance with store-and-forward operations.

If the configuration information indicates that the first UE 820a is allowed to transmit emergency alert messages in accordance with store-and-forward operations, the configuration information may indicate a type of geographic area, referred to here as “relay geographic area type”, associated with the first UE 820a transmitting (e.g., relaying) emergency alert messages. For example, the relay geographic area type may indicate whether the first UE 820a must be within the target area associated with the emergency alert message to perform the relaying of the emergency alert message according to the store-and-forward operation or if the first UE 820a may be within an extended area that is based on the target area. For example, the relay geographic area type may indicate that the first UE 820a may relay the emergency alert message according to the store-and-forward operation if the first UE 820a is within a shape that is extended beyond the target area by a distance ‘D’ (e.g., within a circle or polygon that is extended beyond the target area by the distance ‘D’). Additionally, the configuration information may indicate a maximum number of hops for the store-and-forward operations.

Additionally, the configuration information may indicate, to the first UE 820a, whether the first UE 820a is allowed to transmit emergency alert messages in accordance with immediate broadcast operations. For example, the configuration information may include a flag, where a first value of the flag indicates that the first UE 820a is allowed to transmit emergency alert messages in accordance with immediate broadcast operations and a second value of the flag indicates that the first UE 820a is not allowed to transmit emergency alert messages in accordance with immediate broadcast operations. If the configuration information indicates that the first UE 820a is allowed to transmit emergency alert messages in accordance with immediate broadcast operations, the configuration information may indicate a type of geographic area, referred to as a “relay geographic area type”, associated with the first UE 820a transmitting (e.g., relaying) emergency alert messages. For example, the relay geographic area type may additionally indicate whether the first UE 820a must be within the target area associated with the emergency alert message to perform the relaying of the emergency alert message according to the immediate broadcast operation.

The configuration information may additionally indicate one or more identifiers of emergency alert messages that the first UE 820a is allowed to transmit according to immediate broadcast operations or according to store-and-forward operations. The identifiers may correspond to WEA Message identifiers.

Additionally, the configuration information may indicate one or more source devices for emergency alert messages that the first UE 820a is allowed to transmit with store-and-forward operations. For example, the configuration information may indicate whether the first UE 820a is allowed to relay emergency alert messages (e.g., via immediate broadcast operations or via store-and-forward operations) for the HPLMN, other PLMNs of the home country of the HPLMN, or other specific PLMNs. In another example, the configuration information may indicate whether the first UE 820a is allowed to relay emergency alert messages (e.g., in accordance with immediate broadcast operations or in accordance with store-and-forward operations) that are received from another relay UE, where the source of the emergency alert message is the HPLMN, other PLMNs of the home country of the HPLMN, or other specific PLMNs.

The configuration information may indicate a maximum duration between the first UE 820a receiving an emergency alert message and no longer transmitting the emergency alert message. In one example, the maximum duration may correspond to a time from the receipt of the emergency alert message from the source PLMN (e.g., if the first UE 820a is aware of the time that the emergency alert message is received from the source PLMN) to the time of the first UE 820a no longer transmitting the emergency alert message. In another example (e.g., where the first UE 820a is not aware of the time of receipt of the emergency alert message from the source PLMN), the maximum duration may correspond to a maximum time between the first UE 820a receiving the emergency alert message from another UE (e.g., the wireless device 805) and no longer transmitting the emergency alert message.

As shown by reference number 804, the first UE 820a may receive, from the wireless device 805, an emergency alert message that indicates an alerting event. The alerting event may involve a natural disaster, a man-made disaster, or a loss of coverage to a wireless network. The emergency alert message may be a WEA message. The first UE 820a may receive the emergency alert message at a first time (T1) and at a first location. The first UE 820a may receive the emergency alert message from the wireless device 805 via a broadcast when the first UE 820a is in-coverage with the wireless device 805 (e.g., as described for FIGS. 3-6). Alternatively, the first UE 820a may receive the emergency alert message from a third UE (not shown in FIG. 8) via a sidelink interface, where the third UE may have received the emergency alert message from a network node or from another UE via a sidelink interface.

In some aspects, the emergency alert message received at 804 may be associated with (e.g., may include) configuration information associated with the first UE 820a relaying (or not relaying) the emergency alert message. That is, while the first UE 820a may receive the configuration information from a serving PLMN or HPLMN, as shown by reference number 802, the emergency alert message may include an extension that includes additional (or alternate) configuration information. Alternatively, the first UE 820a may not receive any configuration information at 802, and may instead receive the configuration information with the emergency alert message at 804.

The configuration information received with the emergency alert message may indicate one or more of: whether the first UE 820a is allowed to transmit the emergency alert message in accordance with an immediate broadcast operation; whether the first UE 820a is allowed to transmit the emergency alert message in accordance with the store-and-forward operation; one or more source devices for emergency alert messages that the first UE 820a is allowed to transmit with store-and-forward operations; a type of the first UE 820a allowed to transmit emergency alert messages with store-and-forward operations; an indication of a maximum duration between the first UE 820a receiving the emergency alert message and no longer transmitting the emergency alert message during the store-and-forward operation; a relay geographic area type associated with transmitting the emergency alert message in accordance with the store-and-forward operation; an indication of a maximum number of hops for the store-and-forward operations, or a periodicity of transmissions of the emergency alert message in accordance with the store-and-forward operation.

If the configuration information within the emergency alert message conflicts with configuration information received from the serving PLMN or HPLMN (e.g., that is configured at 802), the first UE 820a may proceed according to the configuration information received with the emergency alert message at 804.

As an example, the emergency alert message may be associated with an indication for the first UE 820a to convey or not convey the emergency alert message to other UEs in a target area. For example, the indication may indicate that the first UE 820a does not use a “Push” method as in FIG. 7, but may or shall use a “Pull” method as described below, or the indication may indicate that the first UE 820a does not transfer the emergency alert message to other UEs using any method. For example, the indication may be a flag. When the flag is set to OFF, the first UE 820a may be configured to not automatically convey the emergency alert message to other UEs in the target area (e.g., using a “Push” method) but to instead convey the emergency alert message to other UEs in the target area only when requested, e.g., using a “Pull” method as described below, which may be useful when network nodes are not damaged and are still operable.

In some cases, to transmit the emergency alert message, the wireless device 805 may divide the emergency alert message into a plurality of segments and transmit, to the first UE 820a, each of the plurality of segments that correspond to the emergency alert message. Each segment, of the plurality of segments, may include a message segment field or information element (e.g., that carries a portion of the emergency alert message) and an indication of a segment number associated with the portion of the emergency alert message. The first UE 820a may then reassemble the emergency alert message by decoding and combining the plurality of segments. That is, to reassemble the emergency alert message, the first UE 820a may decode and combine the portions of the emergency alert message (e.g., each received within one of the plurality of segments) according to an order of the segment numbers associated with each portion of the emergency alert message.

As shown by reference number 806, the first UE 820a may store the emergency alert message in a memory of the first UE 820a. The first UE 820a may store the emergency alert message in the memory of the first UE 820a after reassembling the emergency alert message. Accordingly, the stored emergency alert message may correspond to a reassembled emergency alert message that includes a plurality of segments of the emergency alert message received from the wireless device 805.

The first UE 820a may store the emergency alert message for a certain period of time (e.g., a validity time that may be received at 804 along with the emergency alert message), after which the first UE 820a may erase the emergency alert message from the memory of the first UE 820a.

As shown by reference number 808, the first UE 820a may move from the first location to a second location. In other words, the UE may be a mobile UE, and after receiving the emergency alert message at the first location, the first UE 820a may move to the second location. The second location may be different from the first location. The second location may be outside of a coverage area of the wireless device 805 (e.g., there is no wireless network coverage at the second location). In some aspects, the first UE 820a may remain at or near to the first location and 808 may not occur.

As shown by reference number 810, the first UE 820a may determine whether one or more transmission conditions associated with the first UE 820a transmitting the emergency alert message (e.g., as described with reference to 812, 814, 816, 818, and 822) are satisfied (e.g., are true). The transmission conditions may correspond to conditions that allow or require the first UE 820a to transmit the emergency alert message. The transmission conditions may include one or more of: (i) a configuration of first UE 820a (e.g., at 802 or 804) to transmit the emergency alert message according to store-and-forward operations; (ii) a determination by the first UE 820a that the first UE 820a is, or may be, within a particular geographic area (e.g., a target area for the emergency alert message or a geographic area defined or indicated by a relay geographic area type that was configured at 802 or 804 in the first UE 820a); (iii) a determination by the first UE 820a that a periodic time has occurred for transmitting the emergency alert message (e.g., a periodic time defined by a periodicity configured in the first UE 820a at 802 or 804); (iv) a determination by the first UE 820a that the first UE 820a is not within network coverage (e.g., is not in coverage of wireless device 805 when wireless device 805 is a network node and not in coverage of any other network node); or (v) a determination by the first UE 820a that a maximum duration for transmitting the emergency alert message using store-and-forward operations or a validity period for the emergency alert message (e.g., as configured or received at 802 or 804) has not yet expired.

In order to determine condition (ii) above, the first UE 820a may determine a location of the first UE 820a (e.g., using a location method such as GNSS or WLAN). To determine condition (iv) above, the first UE 820a may scan for network coverage across different radio frequencies and different bands and for different RATs. In some aspects, the first UE 820a may transmit the emergency alert message (e.g., at 822) when the first UE 820a determines that all of the conditions (e.g., as in (i) to (v) above) are satisfied (e.g., true). Here, the first UE 820a may refrain from transmitting the emergency alert message (e.g., at 822) when the first UE 820a determines that any of the conditions (e.g., as in (i) to (v) above) are not satisfied (e.g., are false). In other aspects, the first UE 820a may transmit the emergency alert message (e.g., at 822) when the first UE 820a determines that all or some of the conditions (e.g., as in (i) to (v) above) are satisfied (e.g., determined to be true). Here, the first UE 820a may refrain from transmitting the emergency alert message (e.g., at 822) when the first UE 820a determines that certain conditions (e.g., as in (i) to (v) above) are not satisfied (e.g., are determined to be false).

When the first UE 820a determines to transmit the emergency alert message (e.g., as described for 810), then and as shown by reference number 812, the first UE 820a may receive, from the second UE 820b, a discovery request message that indicates that a purpose of the discovery request message is to receive the emergency alert message. In other words, the second UE 820b may broadcast a request for the emergency alert message (e.g., to all UEs nearby to the second UE 820b), where the request may be received by the first UE 820a. In this case, the first UE 820a may not be configured by the network node at 804 to propagate the emergency alert message to other UEs in a target area, e.g., using a “Push” method as in FIG. 7. However, by transmitting the discovery request message at 812, the second UE 820b may advertise that the second UE 820b has not received any emergency alert messages for a period of time (e.g., because the second UE 820b is out of network coverage). The first UE 820a may receive the discovery request message at a second time (T2) and after moving to the second location if 808 occurs. In other words, at the second time and possibly after moving to the second location, which may be out-of-coverage with the wireless device 805, the first UE 820a may receive the request from the second UE 820b that would otherwise not be able to receive the emergency alert message.

It is noted that when the first UE 820a determines (e.g., at 810) to refrain from transmitting the emergency alert message at 822, the first UE 820a may either not listen for and not receive a discovery request message at 812 or may ignore such a discovery request message if received and may not perform any actions described with reference to 812, 814, 816, 818, or 822.

When 812 occurs and the first UE 820a has determined (e.g., at 810) to transmit the emergency alert message, then as shown by reference number 814, the first UE 820a may transmit, and the second UE 820b may receive, a response to the discovery initiation message. The first UE 820a may include, in the transmission of the response, an indication or indications of characteristics of the emergency alert message, such as: a type of emergency alert message; a type of alerting event; an emergency alert message identifier or serial number; a target area for the emergency alert message; or an age of the emergency alert message, which may be a time interval since the first UE 820a received the emergency alert message at 804 (e.g., a time T2−T1) or a time interval since the emergency alert message was first transmitted by a network node prior to being transmitted by wireless device 805. These indications of characteristics of the emergency alert message may assist the second UE 820b in deciding whether to receive the emergency alert message from the first UE 820a as described below. Additionally, the response at 814 may include an indication or indications of a quantity of emergency alert messages stored at the first UE 820a, an indication of a quantity of hops between a source device of the emergency alert message and the first UE 820a, or an identifier associated with a source device of the emergency alert message.

As shown by reference number 816, the second UE 820b may authenticate the first UE 820a. The authentication may be based on an RSA private key-public key pair, an elliptic curve private key-public key pair, or a TLS protocol. During the authentication, the first UE 820a may send, to the second UE 820b, authentication information associated with the first UE 820a. The authentication information associated with the first UE 820a may include a public key certificate for the first UE 820a (e.g., an international telecommunication union (ITU) defined key certificate). The second UE 820b may use the authentication information associated with the first UE 820a (e.g., the public key certificate for the first UE 820a) to authenticate the first UE 820a (e.g., to authenticate an identity of the first UE 820a). A successful authentication of the first UE 802a may enable a higher level of trust in the first UE 820a by the second UE 820b. Additionally, or alternatively, a successful authentication of the first UE 820a may enable the second UE 820b to receive the emergency alert message from the first UE 820a (e.g., the second UE 820b may not be configured to receive emergency alert messages from any UEs with which the second UE 820b is unable to perform a successful authentication). In some cases, the authentication at 816 may occur partly during discovery (e.g., at 812 and 814) or partly or wholly during a unicast connection establishment (e.g., at 818). In some cases, the authentication at 816 may not occur.

As shown by reference number 818, the first UE 820a and the second UE 820b may establish a unicast connection. For example, the UE 820 and the UE 820b may establish a ProSe direct link using sidelink signaling. In some cases, the unicast connection may correspond to a sidelink RRC connection between the first UE 820a and the second UE 820b.

As shown by reference number 822, the first UE 820a may transmit, to the second UE 820b, the emergency alert message in accordance with a store-and-forward operation. The first UE 820a may transmit the emergency alert message via the unicast connection established at 818. The first UE 820a may transmit the emergency alert message to the second UE 820b when the second UE 820b is, or may be, in the target area (or close to the target area) for the emergency alert message. The first UE 820a may transmit the response at 814 and the emergency alert message at 822 only when the first UE 820a has received an indication at 802 or 804 for the first UE 820a to convey the emergency alert message to other UEs in a target area when requested or, in some other aspects, when no indication for transferring the emergency alert message was received at 802 or 804. For example, if the indication is a flag and the flag is set to OFF, the first UE 820a may transfer the emergency alert message based at least in part on the discovery request message at 812. The first UE 820a may not transmit the emergency alert message to the second UE 820b without first receiving the discovery request message at 812. The first UE 820a may transmit the emergency alert message at a second time (T2), which may occur after the first time. The first UE 820a may transmit the emergency alert message via a sidelink interface. The first UE 820a may transmit the emergency alert message at the second location. The first UE 820a may include at 822 any configuration information received with the emergency alert message at 804 to enable the second UE 820b to determine whether or how the emergency alert message may be conveyed to other UEs.

In some cases, the first UE 820a may transmit the emergency alert message to the second UE 820b without re-segmenting the emergency alert message. That is, the first UE 820a may transmit the reassembled emergency alert message to the second UE 820b at 822. In some other cases, the first UE 820a may re-segment the emergency alert message prior to transmitting the emergency alert message to the UE 820b. For example, the first UE 820a may divide the emergency alert message into a plurality of segments, and transmit the plurality of segments to the second UE 820b via the unicast link. The size of each segment included in the unicast transmission from the first UE 820a at 822 may be the same as or different from the size of each segment of the emergency alert message received from the wireless device 805 at 804.

The operations described with reference to 812, 814, 816, 818, and 822 may be referred to as a “Pull” method for transferring the emergency alert message because a UE that has not yet received the emergency alert message (in this case the second UE 820b) needs to first send a request for the emergency alert message to a UE that has received the emergency alert message (in this case the first UE 820a) in order to receive the emergency alert message. The messages transferred at each of the operations at 812, 814, 816, 818, and 822 may be ProSe messages for sidelink signaling in one aspect.

As indicated above, FIG. 8 is provided as an example. Other examples may differ from what is described with regard to FIG. 8.

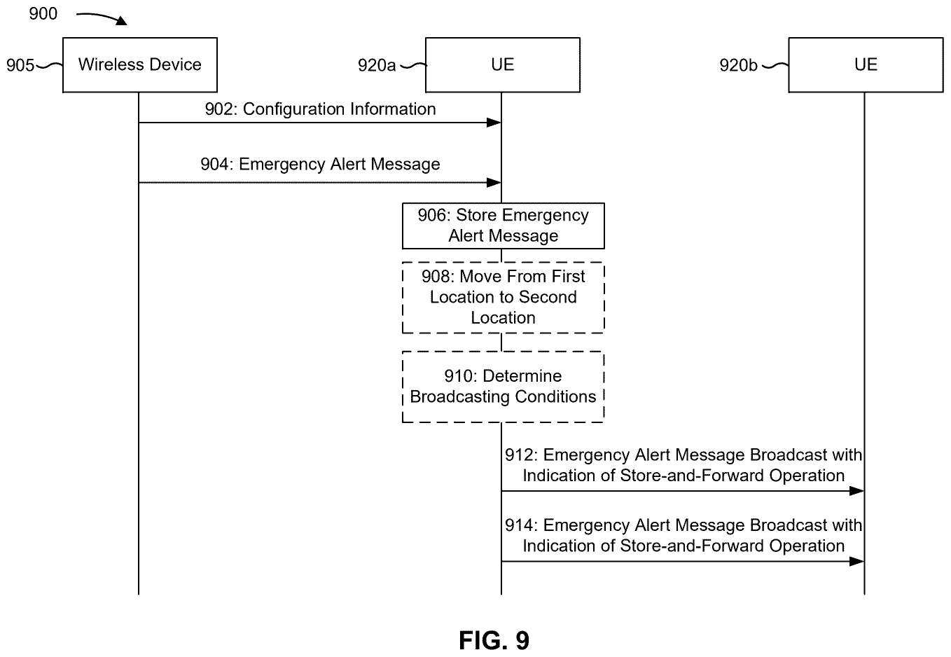

FIG. 9 is a diagram illustrating an example 900 associated with transmitting emergency alert messages during an alerting event. In particular, FIG. 9 illustrates an example of a first UE 920a broadcasting a wireless message (e.g., an emergency alert message) in accordance with a store-and-forward operation. As shown in FIG. 9, example 900 includes communication between a wireless device 905, a first UE (e.g., UE 920a), and a second UE (e.g., UE 920b). In some aspects, the wireless device 905, the first UE 920a, and the second UE 920b may be included in a wireless network, such as wireless network 100. The wireless device 905 may be a network node (e.g., a network node 110 or a network node 610, as described herein) or may be a UE (e.g., a UE 120). Additionally, the UEs may be examples of or include aspects of the UEs described with reference to FIGS. 1 through 8.

As shown by reference number 902, the first UE 920a may receive, from the wireless device 905, configuration information for store-and-forward operations. In some other examples, the first UE 920a may receive the configuration information from another wireless device that is associated with a serving PLMN or HPLMN. Additionally, or alternatively, the first UE 920a may receive the configuration information from a packet core function (PCF) or the configuration information may be configured in a universal SIM (USIM). The configuration information may correspond to configuration information that is preconfigured by a serving PLMN or HPLMN associated with the first UE 920a. The configuration information may indicate, to the first UE 920a, one or more parameters or configurations associated with the first UE 920a performing store-and-forward operations or otherwise communicating wireless messages (e.g., emergency alert messages) to one or more other UEs via a sidelink. In the example 900, the configuration information may authorize the first UE 920a (e.g., a 5G ProSe UE-to-network relay UE) to perform PWS deferred relaying.

In the example 900, the configuration information may indicate that the first UE 920a is allowed to transmit emergency alert messages in accordance with a deferred broadcast operation, which may include a store-and-forward operation. That is, the configuration information may include a flag, where a first value of the flag indicates that the first UE 920a is allowed to transmit emergency alert messages in accordance with deferred broadcast operations and a second value of the flag indicates that the first UE 920a is not allowed to transmit emergency alert messages in accordance with deferred broadcast operations. In the example 900, the flag may be set to the first value indicating that the first UE 920a is allowed to transmit emergency alert messages in accordance with deferred broadcast operations.

If the configuration information indicates that the first UE 920a is allowed to transmit emergency alert messages in accordance with deferred broadcast operations, the configuration information may indicate a type of geographic area, referred to as a “relay geographic area type”, associated with the first UE 920a transmitting emergency alert messages. For example, the relay geographic area type may indicate whether the first UE 920a must be within the target area associated with the emergency alert message to perform the relaying of the emergency alert message according to the deferred broadcast operation or if the first UE 920a may be within an extended area that is based on the target area. For example, the relay geographic area type may indicate that the first UE 920a may relay the emergency alert message according to the deferred broadcast operation if the first UE 920a is within a shape that is extended beyond the target area by a distance ‘D’ (e.g., within a circle or polygon that is extended beyond the target area by the distance ‘D’). In some cases, the configuration information may also indicate, for the deferred broadcast operations, a periodicity for the first UE 920a to broadcast emergency alert messages (e.g., a periodicity of deferred broadcast). Additionally, the configuration information may indicate a maximum number of hops for the store-and-forward operations (e.g., that are included in the deferred broadcast operations).

Additionally, the configuration information may indicate, to the first UE 920a, whether the first UE 920a is allowed to transmit emergency alert messages in accordance with immediate broadcast operations. For example, the configuration information may include a flag, where a first value of the flag indicates that the first UE 920a is allowed to transmit emergency alert messages in accordance with immediate broadcast operations and a second value of the flag indicates that the first UE 920a is not allowed to transmit emergency alert messages in accordance with immediate broadcast operations. If the configuration information indicates that the first UE 920a is allowed to transmit emergency alert messages in accordance with immediate broadcast operations, the configuration information may indicate a type of geographic area, referred to as a “relay geographic area type”, associated with the first UE 920a transmitting emergency alert messages. For example, the relay geographic area type may additionally indicate whether the first UE 920a must be within the target area associated with the emergency alert message to perform the relaying of the emergency alert message according to the immediate broadcast operation.

The configuration information may additionally indicate one or more identifiers of emergency alert messages that the first UE 920a is allowed to transmit according to immediate broadcast operations or according to store-and-forward operations (e.g., including deferred broadcast operations). The identifiers may correspond to WEA Message identifiers.

Additionally, the configuration information may indicate one or more source devices for emergency alert messages that the first UE 920a is allowed to transmit with store-and-forward operations. For example, the configuration information may indicate whether the first UE 920a is allowed to relay emergency alert messages (e.g., via immediate or deferred broadcast operations) for the HPLMN, other PLMNs of the home country of the HPLMN, or other specific PLMNs. In another example, the configuration information may indicate whether the first UE 920a is allowed to relay emergency alert messages (e.g., in accordance with immediate or deferred broadcast operations) that are received from another relay UE, where the source of the emergency alert message is the HPLMN, other PLMNs of the home country of the HPLMN, or other specific PLMNs.

The configuration information may additionally indicate a maximum duration between the first UE 920a receiving an emergency alert message and no longer transmitting the emergency alert message. In one example, the maximum duration may correspond to a time from the receipt of the emergency alert message from the source PLMN (e.g., if the first UE 920a is aware of the time that the emergency alert message is received from the source PLMN) to the time of the first UE 920a no longer transmitting the emergency alert message. In another example (e.g., where the first UE 920a is not aware of the time of receipt of the emergency alert message from the source PLMN), the maximum duration may correspond to a maximum time between the first UE 920a receiving the emergency alert message from another UE (e.g., the wireless device 905) and no longer transmitting the emergency alert message.

As shown by reference number 904, the first UE 920a may receive, from the wireless device 905, an emergency alert message that indicates an alerting event. The emergency alert message may correspond to a CMAS message received via a SIB, such as a SIB8 for 5G NR or a SIB12 for LTE. Additionally, the emergency alert message may correspond to an EWTS message received via a SIB6 or a SIB7 for 5G NR. The first UE 920a may receive the emergency alert message at a first time (T1) and at a first location. The first UE 920a may receive the emergency alert message from the wireless device 905 via a broadcast when the first UE 920a is in-coverage with the wireless device 905 (e.g., as described for FIGS. 3-5). The first UE 920a may receive the emergency alert message from a network node (e.g., the wireless device 905) or from a third UE (e.g., the wireless device 905) via a sidelink interface, where the third UE may have received the emergency alert message from a network node or from another UE via a sidelink interface.

In some aspects, the emergency alert message may be associated with configuration information associated with the first UE 920a relaying (or not relaying) the emergency alert message. That is, while the first UE 920a may receive the configuration information from a serving PLMN or HPLMN, as shown by reference number 902, the emergency alert message may include an extension that includes additional (or alternate) configuration information. Alternatively, the first UE 920a may not receive any configuration information at 902, and may instead receive the configuration information with the emergency alert message at 904.

The configuration information received with the emergency alert message may indicate one or more of: whether the first UE 920a is allowed to transmit the emergency alert message in accordance with an immediate broadcast operation; whether the first UE 920a is allowed to transmit the emergency alert message in accordance with the store-and-forward operation; one or more source devices for emergency alert messages that the first UE 920a is allowed to transmit with store-and-forward operations; a type of the first UE 920a allowed to transmit emergency alert messages with store-and-forward operations; an indication of a maximum duration between the first UE 920a receiving the emergency alert message and no longer transmitting the emergency alert message using the store-and-forward operation; a geographic area (e.g., a relay geographic area type) associated with transmitting the emergency alert message in accordance with the store-and-forward operation; an indication of a maximum number of hops for the store-and-forward operations; or a periodicity of broadcast transmissions of the emergency alert message in accordance with the store-and-forward operation.

If the configuration information within the emergency alert message conflicts with configuration information received from a serving PLMN or HPLMN (e.g., that is configured at 902), the first UE 920a may proceed according to the configuration information received with the emergency alert message at 904.

As an example, the emergency alert message may be associated with an indication for the first UE 920a to convey the emergency alert message to other UEs in a target area. The indication and the emergency alert message may be included in a SIB transmitted by the wireless device 905 via a broadcast (e.g., from a network node) or in a sidelink communication (e.g., from a third UE). The first UE 920a may be within the target area when the emergency alert message is received, or alternatively, the first UE 920a may be outside the target area when the emergency alert message is received. In some aspects, the indication associated with the emergency alert message may be a flag or other parameter that indicates that the first UE 920a is to convey the emergency alert message to other UEs and may further indicate a method or methods by which the conveyance to other UEs is to be supported. For example, when the indication is a flag and when the flag is set to “ON,” the first UE 920a may be configured to automatically convey the emergency alert message to other UEs in the target area using a particular predefined or preconfigured method. In some cases, the predefined or preconfigured method may be configured at 902 by the configuration information.

In an aspect, the wireless device 905 may include the indication in, or with, the emergency alert message transmitted by the wireless device 905 at 904, for the first UE 920a to convey the emergency alert message to other UEs in the target area when an operator for the wireless device 905 may not be able to broadcast the emergency alert message throughout all of the target area. For example, the alerting event for the emergency alert message may correspond to a disaster event (e.g., a hurricane, tornado, tsunami or wildfire) in which some network nodes for the operator of the wireless device 905 may have been damaged or otherwise rendered inoperable by the disaster event. Some of the damaged or inoperable network nodes may be needed to broadcast the emergency alert message throughout all of the target area, but may be unable to do so. The operator may then configure the wireless device 905 or another element or elements (e.g., a CBC, AMF or MME) in a network for the operator to include the indication in, or with, the emergency alert message that UEs that receive the emergency alert message (e.g., the first UE 920a) are to convey the emergency alert message to other UEs in the target area (e.g., the second UE 920b). In these conditions, the wireless device 905 may also include authentication information in the emergency alert message or sent in association with the emergency alert message at 904, as described later herein.

In some cases, to transmit the emergency alert message, the wireless device 905 may divide the emergency alert message into a plurality of segments and transmit, to the first UE 920a, each of the plurality of segments that correspond to the emergency alert message. Each segment, of the plurality of segments, may include a message segment field or information element (e.g., that carries a portion of the emergency alert message) and an indication of a segment number associated with the portion of the emergency alert message. The first UE 920a may then reassemble the emergency alert message by decoding and then combining the plurality of segments. That is, to reassemble the emergency alert message, the first UE 920a may combine the portions of the emergency alert message (e.g., each received within one of the plurality of segments) according to an order of the segment numbers associated with each portion of the emergency alert message.

As shown by reference number 906, the first UE 920a may store the emergency alert message in a memory of the first UE 920a. The first UE 920a may store the emergency alert message in the memory of the first UE 920a after reassembling the emergency alert message. Accordingly, the stored emergency alert message may correspond to a reassembled emergency alert message that includes a plurality of segments of the emergency alert message received from the wireless device 905 at 904.

The first UE 920a may store the emergency alert message for a certain period of time (e.g., a validity time), after which the first UE 920a may erase the emergency alert message from the memory of the first UE 920a. The period of time may correspond to an expected duration of the alerting event, an expected duration of a warning for the alerting event or a validity time for the emergency alert message and may be received at 902 in association with the configuration information. Alternatively, the period of time may be received at 904 in association with the emergency alert message or may be preconfigured in the first UE 920a by the configuration information at 902. A validity time may comprise a time, a date or a date and time after which information in the emergency alert message is no longer valid or (fully) trustworthy. Additionally, or alternatively, the validity time may correspond to the maximum duration between the first UE 920a receiving the emergency alert message and no longer transmitting the emergency alert message during store-and-forward operations.

The first UE 920a may store the emergency alert message regardless of whether the first UE 920a is in the target area or outside of the target area. The first UE 920a may display the emergency alert message to a user of the first UE 920a when the first UE 920a is within the target area, or the first UE 920a may not display the emergency alert message to the user when the first UE 920a is outside of the target area.

As shown by reference number 908, the first UE 920a may move from the first location to a second location. In other words, the first UE 920a may be a mobile UE, and after receiving the emergency alert message at the first location, the first UE 920a may move to the second location. The second location may be different from the first location. The second location may be outside of a coverage area of the wireless device 905 (e.g., there is no wireless network coverage at the second location). In some aspects, the first UE 920a may remain at or near to the first location and 908 may not occur.

As shown by reference number 910, the first UE 920a may determine broadcasting conditions associated with broadcasting the emergency alert message (e.g., as described with reference to 912 and 914). The broadcasting conditions may correspond to conditions which allow or require the first UE 920a to broadcast the emergency alert message. The broadcasting conditions may include one or more of: (i) a configuration of first UE 920a (e.g., at 902 or 904) to transmit the emergency alert message according to store-and-forward operations; (ii) a determination by the first UE 920a that the first UE 920a is, or may be, within a particular geographic area (e.g., a target area for the emergency alert message or a geographic area defined or indicated by a relay geographic area type that was configured at 902 or 904 in the first UE 920a); (iii) a determination by the first UE 920a that a periodic time has occurred for broadcasting the emergency alert message (e.g., a periodic time defined by a periodicity configured in the first UE 920a at 902 or 904); (iv) a determination by the first UE 920a that the first UE 920a is not within network coverage (e.g., is not in coverage of wireless device 905 when the wireless device 905 is a network node and is not in coverage of any other network node); and (v) a determination by the first UE 920a that a maximum duration for transmitting the emergency alert message using store-and-forward operations or a validity period for the emergency alert message (e.g., as configured or received at 902 or 904) has not yet expired.

In order to determine condition (ii) above, the first UE 920a may determine a location of the first UE 920a (e.g., using a location method such as GNSS or WLAN). To determine condition (iii) above, the first UE 920a may determine a broadcasting periodicity of the emergency alert message (e.g., a time interval between consecutive broadcasts of the emergency alert message). In some cases, the first UE 920a may determine the broadcasting periodicity of the emergency alert message based on the configuration information (e.g., received at 902 or received with the emergency alert message at 904). In order to determine condition (iv) above, the first UE 920a may scan for network coverage across different radio frequencies and different bands and for different RATs. In some aspects, the first UE 920a may broadcast the emergency alert message (e.g., at 912 or 914) when the first UE 920a determines that all the conditions (e.g., as in (i) to (v) above) are satisfied (e.g., determined to be true). Here, the first UE 920a may refrain from broadcasting the emergency alert message (e.g., at 912 or 914) when the first UE 920a determines that any of the conditions (e.g., as in (i) to (v) above) are not satisfied (e.g., determined to be false). In other aspects, the first UE 920a may broadcast the emergency alert message (e.g., at 912 or 914) when the first UE 920a determines that all or some of the conditions (e.g., as in (i) to (v) above) are satisfied (e.g., determined to be true). Here, the first UE 920a may refrain from broadcasting the emergency alert message (e.g., at 912 or 914) when the first UE 920a determines that certain of these conditions are not satisfied (e.g., determined to be false).

When the first UE 920a determines to broadcast the emergency alert message (e.g., as described for 910), then, as shown by reference number 912, the first UE 920a may broadcast the emergency alert message. That is, the first UE 920a may begin periodically broadcasting a latest version of the stored emergency alert message. The broadcast may include both the emergency alert message and an indication of the store-and-forward operation associated with the emergency alert message. The first UE 920a may broadcast the emergency alert message using a sidelink broadcast. For example, the first UE 920a may use a destination layer-2 identifier to broadcast the emergency alert message that is indicative of the emergency alert message being associated with the store-and-forward operation. In some cases, the second UE 920b may prioritize receiving emergency alert messages transmitted using destination layer-2 identifiers that are indicative of immediate broadcast operations (e.g., over emergency alert messages that are transmitted using destination layer-2 identifiers that are indicative of store-and-forward operations).

In some cases, the first UE 920a may transmit the emergency alert message to the second UE 920b without re-segmenting the emergency alert message. That is, the first UE 920a may transmit the reassembled emergency alert message to the second UE 920b at 916. In some other cases, the first UE 920a may re-segment the emergency alert message prior to broadcasting the emergency alert message. For example, the first UE 920a may divide the emergency alert message into a plurality of segments, and broadcast the plurality of segments. The size of each segment included in the broadcast from the first UE 920a at 912 may be the same as or different from the size of each segment of the emergency alert message received from the wireless device 905 at 904.

As shown by reference number 914, the first UE 920a may broadcast the emergency alert message again (e.g., in accordance with the periodicity determined at 910). In some cases, the first UE 920a may continue to broadcast the emergency alert message according to the determined periodicity until the first UE 920a receives an updated version of the emergency alert message (e.g., associated with a later serial number) or until a broadcast duration associated with the emergency alert message, and indicated via the configuration information at 902 or 904, has expired.

In some aspects, the first UE 920a may perform the first broadcast of the emergency alert message at 912 immediately after receiving and (if needed) after reassembling the emergency alert message at 904. This may correspond to an immediate broadcast and may be controlled by configuration information received by the first UE 920a at 902 or 904 (e.g., by configuration information that is related to an immediate broadcast). The first UE 920a may then perform the second broadcast of the emergency alert message at 914 according to a periodicity determined at 910 (e.g., at a time interval ‘T’ after the broadcast at 912 when the periodicity equals ‘T’) or if the conditions (i) to (v) determined at 910 allow further broadcast using store-and-forward operations.

In some other aspects (e.g., if the first UE 920a is not configured for immediate broadcasting), the first broadcast of the emergency alert message at 912 may occur according to a periodicity determined at 910 (e.g., may occur after a time interval ‘T’ following receiving the emergency alert message at 904 when the periodicity equals ‘T’). The first UE 920a may further determine whether to broadcast the emergency alert message based on the conditions determined at 910 (e.g., based on whether the first UE 920a is in network coverage or out of network coverage). As an example, if the first UE 920a is out of network coverage (e.g., is not in coverage of the wireless device 905 when the wireless device 905 is a network node and is not in coverage of any other network node), the first UE 920a may broadcast the emergency alert message periodically (e.g., at time intervals of ‘T’). However, if the first UE 920a is in network coverage (e.g., is in coverage of the wireless device 905 when the wireless device 905 is a network node or is in coverage of some other network node), the first UE 920a may refrain from broadcasting the emergency alert message periodically. If the first UE 920a later goes out of network coverage, the first UE 920a may resume broadcasting the emergency alert message periodically. However, if the first UE 920a receives a more recent version of the emergency alert message while in network coverage or receives configuration information while in network coverage that changes the broadcasting of the emergency alert message, the first UE 920a may start to broadcast the new version of the emergency alert message or follow the new configuration information when the first UE 920a is later out of network coverage.

The emergency alert messages broadcast by the first UE 920a at 912 and 914 may correspond to the first UE 920a broadcasting a message that includes the emergency alert message. The message may include a deferred broadcast flag, which may indicate to any other UEs that receive the emergency alert message from the first UE 920a (e.g., the second UE 920b) whether the emergency alert message is allowed to be forwarded using a deferred broadcast. Additionally, the message broadcast by the first UE 920a may include: an identifier associated with a source device of the emergency alert message (e.g., a source PLMN identifier, a TAC, or a cell identifier); an indication of whether the emergency alert message can be transmitted in accordance with store-and-forward operations; authentication information for the emergency alert message; a geographical area (e.g., a relay geographic area type) associated with broadcasting the emergency alert message; an indication of a maximum time duration associated with no longer broadcasting the emergency alert message; a periodicity associated with broadcasting the emergency alert message; or an indication of a maximum number of hops associated with broadcasting the emergency alert message. The message may also include an indication of a quantity of hops associated with the emergency alert message. That is, the first UE 920a may determine the quantity of hops associated with the emergency alert message received at 904, increment the quantity by one, and transmit an indication of the incremented quantity of hops within the message.

As indicated above, FIG. 9 is provided as an example. Other examples may differ from what is described with regard to FIG. 9.

In some instances of transferring an emergency alert message from a first UE to a second UE using a sidelink interface (e.g., as illustrated in FIGS. 6A, 6B, 7, 8, and 9), the second UE may not know whether the emergency alert message is authentic. For example, an attacker could use the first UE to transfer a spoofed emergency alert message containing false information to other UEs (e.g., the second UE) in order to cause inappropriate, unnecessary undesirable, or dangerous behavior by the users of the other UEs. For example, the inappropriate, unnecessary, undesirable, or dangerous behavior might include movement of users away from an area or location, movement of users towards an area or location, general panic, congestion of roads, congestion of communication systems, congestion and injury in a confined space (e.g., sports stadium or concert arena), or physical violence.

Accordingly, the second UE may perform an authentication of the first UE (e.g., may authenticate an identity of the first UE), and a successful authentication may indicate (e.g., directly or indirectly) that the second UE may be trusted. This can be possible for the “Push” and “Pull” methods of transferring an emergency alert message as described for 716 in FIGS. 7 and 816 in FIG. 8, but may not always be possible for a broadcast method of transferring an emergency alert message as described in FIG. 9.

To avoid security problems associated with transferring an emergency alert message, the first UE could transfer authentication information along with the emergency alert message to the second UE (e.g., at 722 in FIG. 7, at 822 in FIG. 8, or at 912 or 914 in FIG. 9), where the authentication information enables the second UE to verify an authenticity of the emergency alert message, and where the emergency alert message may include a target area and a validity time for the emergency alert message. For example, the authentication information may comprise a digital signature for the emergency alert message (e.g., a digital signature for the content of the wireless message and the target area and validity time if not part of the content of the emergency alert message). The digital signature may be created using a private authentication key known only to the original sender of the emergency alert message (e.g., a government agency, network operator or other trusted party). The private authentication key may be associated with a public authentication key that is widely available (e.g., for a Rivest-Shamir-Adleman (RSA) or elliptic curve private key-public key pair). The public key may already be known to the second UE or may be provided to the second UE in a key certificate (e.g., an international telecommunication union (ITU) defined key certificate). The key certificate may be part of the authentication information transferred to the second UE by the first UE or may be preconfigured in the second UE (e.g., by a serving PLMN or home PLMN operator for the second UE) and may be configured as at 702 in FIG. 7, 802 in FIG. 8 or 902 in FIG. 9. The second UE may verify the correctness of the digital signature using the public authentication key. If the digital signature is verified, the second UE may consider the emergency alert message including any validity time or target area to be authentic and may present the emergency alert message to a user of the second UE if the second UE is in, or may be in, the target area for the emergency alert message and if the validity time has not yet expired. The second UE may also transfer the emergency alert message to other UEs (e.g., as described in FIGS. 6 to 9) along with the authentication information if the validity time has not yet expired. If the digital signature is not verified, the second UE may discard the emergency alert message. The first UE may receive the authentication information along with the emergency alert message from a network node via a broadcast or from a third UE via a sidelink interface (e.g., as at 704 in FIG. 7, 804 in FIG. 8, or 904 in FIG. 9) and may verify the authenticity of the emergency alert message using the public key in the same way as the second UE before sending the emergency alert message to the second UE.

In some examples of relaying an emergency alert message (e.g., as described with reference to operations 712, 714, 716, 718, and 722 in FIG. 7; with reference to 812, 814, 816, 818, and 822 in FIG. 8; or with reference to operations 912 and 914 in FIG. 9), (e.g., during a disaster event) a network may have coverage over a first area within a target area for an emergency alert message, may not have coverage over a second area within the target area for the emergency alert message, or may not have coverage over a third area near to but outside of the target area for the emergency alert message. The first area, second area, and third area may be non-overlapping and may each be continuous or discontinuous (e.g., may each comprise two or more disconnected smaller areas when discontinuous but not when continuous). It may be beneficial, or at least acceptable, to not relay the emergency alert message using store-and-forward operations within the first area because UEs in the first area can be within network coverage and thus may receive the emergency alert message directly from a network node or from another relay UE using immediate broadcast. However, it may be beneficial to relay the emergency alert message using store-and-forward operations within the second area because UEs in the second area may not be within network coverage and thus may not receive the emergency alert message directly from a network node and possibly not from another relay UE using immediate broadcast. Similarly, it may be beneficial to relay the emergency alert message using store-and-forward operations within the third area because UEs in the third area may not be within network coverage and thus may not receive the emergency alert message directly from a network and possibly not from another relay UE using immediate broadcast. Although UEs in the third area may not display the emergency alert message to a user (because the third area is outside the target area), some of these UEs may later enter the target area because it is near to the third area, but may not then receive the emergency alert message from a network node or other relay UE if then within the first area in the target area where there is network coverage. Some of the UEs in the third area which later enter the target area may then be unable to display the emergency alert message to a user and unable to relay the emergency alert message to other UEs in the target area.

Accordingly, UEs that receive the emergency alert message may be configured (e.g., as at 704 in FIG. 7, 804 in FIG. 8 or 904 in FIG. 9) to relay the emergency alert message to other UEs (e.g., using the “Push” method of FIG. 7, the “Pull” method of FIG. 8 or the broadcast method of FIG. 9) when (e.g., when and only when) the UE determines that the UE is, or may be, located in the second area or the third area. The configuration may use the relay geographic area type described with reference to FIG. 7, FIG. 8, and FIG. 9. The relay geographic area type may include a definition or description of a geographic area, which may be referred to as a relay geographic area. The relay geographic area may comprise: the second area (e.g., if there is no third area or if relaying in the third area is not desired), the second area and the third area, or the third area (e.g., if there is no second area). It is noted that the relay geographic area can be: (i) a subset of the target area (e.g., if the second area is smaller than the target area and there is no third area); (ii) a superset of the target area (e.g., if the second area is the same as the target area and there is a third area); or (iii) overlapping with the target area (e.g., if the second area is smaller than the target area and there is a third area). A UE that is storing the emergency alert message may then relay the emergency alert message to other UEs when (e.g., when and only when) the UE determines that that UE is, or may be, within the relay geographic area.

In order to avoid congestion of, or interference to, other sidelink signaling, a first UE (e.g., the first UE 720a, 820a or 920a) may determine a transmission periodicity or broadcasting periodicity of an emergency alert message (e.g., as at 710 in FIG. 7, 810 in FIG. 8 or 910 in FIG. 9) based on a quantity of other UEs that are broadcasting, to the first UE, emergency alert messages over a sidelink interface. For example, the first UE may increase a periodicity (e.g., a periodic interval) of broadcasting the emergency alert messages when a large number of nearby relay UEs are performing broadcasts (e.g., when the quantity of UEs that are broadcasting is large or exceeds a threshold quantity) to avoid congestion of, and interference to, sidelink signaling. In some cases, when the first UE is out of network coverage, the first UE may count the number ‘N’ of other relay UEs and intermediate relay UEs from which the first UE is currently receiving deferred or immediate broadcasts of emergency alert messages (e.g., during a certain period of time such as 1 minute or 5 minutes). Then, the first UE may increase a periodic timer ‘T’ as ‘N’ increases. Here, the first UE may broadcast the stored emergency alert messages according to the interval ‘T’ (e.g., may equate the broadcasting periodicity of the emergency alert message to ‘T’).

Additionally, or alternatively, the first UE may determine whether some other relay UEs or intermediate relay UEs are broadcasting more recent versions of emergency alert messages that are currently stored by the first UE or are broadcasting emergency alert messages that are not currently stored by the first UE. Here, the first UE may suspend transmission or broadcasting of the emergency alert message, and instead receive and store the more recent versions of emergency alert messages, or the emergency alert messages not currently stored by the first UE, that are received from other relay UEs or intermediate relay UEs. Additionally, the first UE may determine that other relay UEs or other intermediate relay UEs are broadcasting or transmitting older versions of emergency alert messages or are not broadcasting at least some of the emergency alert messages currently stored by the first UE. Here, the first UE may begin transmitting or broadcasting the emergency alert message as soon as possible. In some cases, the first UE may adjust the periodicity or timing of broadcasting or transmitting emergency alert messages on a per-emergency-alert-message basis. That is, the first UE may broadcast a first stored emergency alert message as soon as possible (e.g., if the version of the first stored emergency alert message is more recent than versions of corresponding emergency alert messages broadcast from other relay UEs or if the first stored emergency alert message is not being broadcast by other UEs) and may delay a broadcast of a second stored emergency alert message according to the time ‘T.’

FIG. 10 is a diagram illustrating an example process 1000 performed, for example, at a UE or an apparatus of a UE (e.g., a UE 120, UE 520, UE 620, UE 720, UE 820, UE 920). Example process 1000 is an example where the apparatus or the UE (e.g., UE 120) performs operations associated with sidelink transmission of wireless messages using store-and-forward operations.

As shown in FIG. 10, in some aspects, process 1000 may include receiving, at a first time, an emergency alert message that indicates an alerting event (block 1010). For example, the UE (e.g., using reception component 1102 or communication manager 1106, depicted in FIG. 11) may receive, at a first time, an emergency alert message that indicates an alerting event, as described above. In particular, the UE may receive the emergency alert message from another UE (e.g., via a sidelink) or from a network node, as described with reference to FIGS. 6A-9.

As further shown in FIG. 10, in some aspects, process 1000 may include transmitting, to a second UE via a sidelink interface and at a second time that occurs after the first time, an indication of both the emergency alert message and a store-and-forward operation associated with the emergency alert message (block 1020). For example, the UE (e.g., using transmission component 1104 or communication manager 1106, depicted in FIG. 11) may transmit, to a second UE via a sidelink interface and at a second time that occurs after the first time, an indication of both the emergency alert message and a store-and-forward operation associated with the emergency alert message, as described above. In particular, the UE may transmit the indication of both the emergency alert message and the store-and-forward operation to a second UE as described with reference to FIGS. 7-9.

As further shown in FIG. 10, in some aspects, process 1000 may include transmitting, via the sidelink interface and at a third time that occurs at or after the second time, the emergency alert message to the second UE in accordance with the store-and-forward operation (block 1030). For example, the UE (e.g., using transmission component 1104 or communication manager 1106, depicted in FIG. 11) may transmit, via the sidelink interface and at a third time that occurs at or after the second time, the emergency alert message to the second UE in accordance with the store-and-forward operation, as described above. In particular, the UE may transmit the emergency alert message to the second UE according to a deferred broadcast, a “Push” method, or a “Pull” method, as described with reference to FIGS. 7-9.

Process 1000 may include additional aspects, such as any single aspect or any combination of aspects described below or in connection with one or more other processes described elsewhere herein.

In a first aspect, process 1000 includes receiving signaling indicating that the emergency alert message can be transmitted in accordance with the store-and-forward operation, wherein transmitting the emergency alert message in accordance with the store-and-forward operation is based at least in part on the signaling.

In a second aspect, receiving the emergency alert message comprises receiving a first plurality of segments that correspond to the emergency alert message, and process 1000 includes reassembling the emergency alert message based at least in part on combining the first plurality of segments, wherein transmitting the emergency alert message is based at least in part on the reassembling.

In a third aspect, transmitting the emergency alert message to the second UE comprises transmitting the reassembled emergency alert message.

In a fourth aspect, process 1000 includes dividing the reassembled emergency alert message into a second plurality of segments that correspond to the reassembled emergency alert message, wherein a first maximum size of each of the first plurality of segments is different from a second maximum size of each of the second plurality of segments, and wherein transmitting the emergency alert message to the second UE comprises transmitting the second plurality of segments to the second UE.

In a fifth aspect, process 1000 includes receiving, at a fourth time that occurs prior to the first time, configuration information associated with store-and-forward operations at the UE, wherein transmitting the emergency alert message is based at least in part on the configuration information.

In a sixth aspect, the configuration information indicates one or more of whether the UE is allowed to transmit emergency alert messages in accordance with immediate broadcast operations, whether the UE is allowed to transmit emergency alert messages in accordance with store-and-forward operations, one or more source devices for emergency alert messages that the UE is allowed to transmit with store-and-forward operations, an indication of a maximum duration between the UE receiving an emergency alert message and no longer transmitting the emergency alert message, a type of geographic area (e.g., a relay geographic area type) associated with transmitting emergency alert messages, an indication of a maximum number of hops for the store-and-forward operations, one or more identifiers of emergency alert messages that the UE is allowed to transmit according to immediate broadcast operations or according to store-and-forward operations, or a periodicity of transmitting or broadcasting the store-and-forward operations.

In a seventh aspect, process 1000 includes receiving, at the first time and with the emergency alert message, configuration information associated with the store-and-forward operation for the emergency alert message, wherein transmitting the emergency alert message is based at least in part on the configuration information.

In an eighth aspect, the configuration information indicates one or more of whether the UE is allowed to transmit the emergency alert message in accordance with an immediate broadcast operation, whether the UE is allowed to transmit the emergency alert message in accordance with the store-and-forward operation, one or more source devices for emergency alert messages that the UE is allowed to transmit with store-and-forward operations, a type of the UE allowed to transmit emergency alert messages with store-and-forward operations, an indication of a maximum duration between the UE receiving the emergency alert message and no longer transmitting the emergency alert message during the store-and-forward operation, a geographic area or type of geographic area (e.g., a relay geographic area type) associated with transmitting the emergency alert message in accordance with the store-and-forward operation, an indication of a maximum number of hops for the store-and-forward operations, or a periodicity of broadcasting or transmitting the emergency alert message in accordance with the store-and-forward operation. When the configuration information indicates a geographic area or a type of geographic area, the process 1000 may include transmitting the indication and the emergency alert message at blocks 1020 and 1030 when the UE is in (or may be in) the geographic area or a geographic area corresponding to the type of geographic area, respectively. Either of these geographic areas may be different to a target geographic area for the emergency alert message (e.g., may be a subset of, a superset of, or overlapping with, the target geographic area).

In a ninth aspect, transmitting the indication and the emergency alert message comprises broadcasting a message that comprises the indication and the emergency alert message.

In a tenth aspect, broadcasting the message comprises broadcasting the message according to a periodicity associated with the store-and-forward operation.

In an eleventh aspect, the periodicity associated with the store-and-forward operation is based at least in part on a quantity of UEs broadcasting, to the UE, one or more emergency alert messages.

In a twelfth aspect, the indication corresponds to a destination layer 2 identifier that is associated with the emergency alert message and that indicates that the emergency alert message is associated with the store-and-forward operation.

In a thirteenth aspect, the message further comprises one or more of an identifier associated with a source device of the emergency alert message, an indication of whether the emergency alert message can be transmitted in accordance with store-and-forward operations, authentication information for the emergency alert message, a geographic area or a type of geographic area (e.g., a relay geographic area type) associated with broadcasting the emergency alert message, an indication of a maximum time duration associated with broadcasting the emergency alert message, a periodicity associated with broadcasting the emergency alert message, or an indication of a maximum number of hops associated with broadcasting the emergency alert message.

In a fourteenth aspect, transmitting the indication comprises transmitting a discovery initiation message that comprises the indication of both the emergency alert message and the store-and-forward operation associated with the emergency alert message, and the process 1000 includes receiving, from the second UE, a response to the discovery initiation message, wherein transmitting the emergency alert message to the second UE is based at least in part on the response.

In a fifteenth aspect, the indication corresponds to a relay service code within the discovery initiation message that is indicative of the emergency alert message and the store-and-forward operation associated with the emergency alert message.

In a sixteenth aspect, the discovery initiation message further comprises one or more of an indication of a quantity of emergency alert messages stored at the UE, an indication of a quantity of hops between a source device of the emergency alert message and the UE, an indication of an age of the emergency alert message, an identifier associated with the emergency alert message, a serial number associated with the emergency alert message, or an identifier associated with a source device of the emergency alert message.

In a seventeenth aspect, process 1000 includes establishing a unicast connection (e.g., a sidelink RRC connection) with the second UE based at least in part on the response to the discovery initiation message, wherein transmitting the emergency alert message comprises transmitting the emergency alert message via the unicast connection.

In an eighteenth aspect, the response to the discovery initiation message comprises an indication of the emergency alert message, and wherein transmitting the emergency alert message to the second UE is based at least in part on the response to the discovery initiation message comprising the indication of the emergency alert message.

In a nineteenth aspect, process 1000 includes receiving, from the second UE, a discovery request message that indicates that a purpose of the discovery request message is to receive the emergency alert message, wherein transmitting the emergency alert message to the second UE is based at least in part on the discovery request message.

In a twentieth aspect, process 1000 includes establishing a unicast connection with the second UE (e.g., a sidelink RRC connection) based at least in part on the discovery request message, wherein transmitting the indication and the emergency alert message comprises transmitting the indication and the emergency alert message via the unicast connection.

In a twenty-first aspect, process 1000 includes transmitting, via the sidelink interface to the second UE, authentication information associated with the UE, wherein the authentication information includes a public key certificate associated with the UE, wherein the authentication information enables the second UE to authenticate the UE.

In a twenty-second aspect, process 1000 includes receiving, at a fourth time that occurs prior to the first time, an initial emergency alert message that indicates the alerting event, storing the initial emergency alert message at the UE in accordance with the store-and-forward operation, and replacing the stored initial emergency alert message with the emergency alert message based at least in part on receiving the emergency alert message after receiving the initial emergency alert message, and the initial emergency alert message and the emergency alert message being associated with a same identifier, wherein transmitting the emergency alert message is based at least in part on the replacing.

In a twenty-third aspect, process 1000 includes transmitting the indication and the emergency alert message when the UE is not in network coverage.

In a twenty-fourth aspect, the emergency alert message is a WEA message or a PWS message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a first UE or a second UE, or a first UE or a second UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the first UE.

In some aspects, the apparatus 1100 may be configured to perform one or more operations described herein in connection with FIGS. 3-9. Additionally, or alternatively, the apparatus 1100 may be configured to perform one or more processes described herein, such as process 1000 of FIG. 10. In some aspects, the apparatus 1100 or one or more components shown in FIG. 11 may include one or more components of a UE 120 described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, sidelink signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of a UE 120 described above in connection with FIG. 1, such as a radio, one or more RF chains, one or more transceivers, or one or more modems, each of which may in turn be coupled with one or more antennas of the UE.

The transmission component 1104 may transmit communications, such as reference signals, sidelink signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of a UE 120 described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, at a first time, an emergency alert message that indicates an alerting event. The transmission component 1104 may transmit, to a second UE via a sidelink interface and at a second time that occurs after the first time, an indication of both the emergency alert message and a store-and-forward operation associated with the emergency alert message. The transmission component 1104 may transmit, via the sidelink interface and at a third time that occurs at or after the second time, the emergency alert message to the second UE in accordance with the store-and-forward operation.

The reception component 1102 may receive signaling indicating that the emergency alert message can be transmitted in accordance with the store-and-forward operation, wherein transmitting the emergency alert message in accordance with the store-and-forward operation is based at least in part on the signaling.

The communication manager 1106 may divide the reassembled emergency alert message into a second plurality of segments that correspond to the reassembled emergency alert message, wherein a first maximum size of each of the first plurality of segments is different from a second maximum size of each of the second plurality of segments, and wherein transmitting the emergency alert message to the second UE comprises transmitting the second plurality of segments to the second UE.

The reception component 1102 may receive, at a fourth time that occurs prior to the first time, configuration information associated with store-and-forward operations at the first UE, wherein transmitting the emergency alert message is based at least in part on the configuration information.

The reception component 1102 may receive, at the first time and with the emergency alert message, configuration information associated with the store-and-forward operation for the emergency alert message, wherein transmitting the emergency alert message is based at least in part on the configuration information.

The communication manager 1106 may establish a unicast connection (e.g., a sidelink RRC connection) with the second UE based at least in part on the response to the discovery initiation message, wherein transmitting the emergency alert message comprises transmitting the emergency alert message via the unicast connection.

The reception component 1102 may receive, from the second UE, a discovery request message that indicates that a purpose of the discovery request message is to receive the emergency alert message, wherein transmitting the emergency alert message to the second UE is based at least in part on the discovery request message.

The communication manager 1106 may establish a unicast connection (e.g., a sidelink RRC connection) with the second UE based at least in part on the discovery request message, wherein transmitting the indication and the emergency alert message comprises transmitting the indication and the emergency alert message via the unicast connection.

The transmission component 1104 may transmit, via the sidelink interface to the second UE, authentication information associated with the UE, wherein the authentication information includes a public key certificate associated with the UE, wherein the authentication information enables the second UE to authenticate the UE.

The reception component 1102 may receive, at a fourth time that occurs prior to the first time, an initial emergency alert message that indicates the alerting event.

The communication manager 1106 may store the initial emergency alert message at the UE in accordance with the store-and-forward operation.

The communication manager 1106 may replace the stored initial emergency alert message with the emergency alert message based at least in part on receiving the emergency alert message after receiving the initial emergency alert message, and the initial emergency alert message and the emergency alert message being associated with a same identifier, wherein transmitting the emergency alert message is based at least in part on the replacing.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

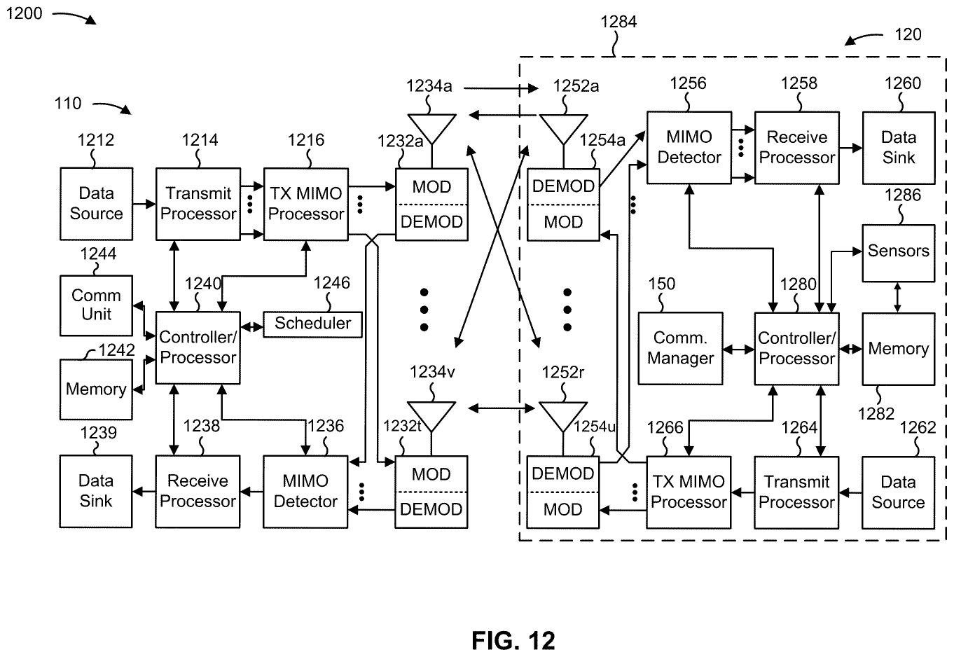

FIG. 12 is a diagram illustrating an example network node 110 in communication with a UE 120 in a wireless network (e.g., the wireless communication network 100).

As shown in FIG. 12, the network node 110 may include a data source 1212, a transmit processor 1214, a transmit (TX) MIMO processor 1216, a set of one or more modems 1232 (shown as 1232a through 1232t), a set of one or more antennas 1234 (shown as 1234a through 1234v), a MIMO detector 1236, a receive processor 1238, a data sink 1239, a controller/processor 1240, a memory 1242, a communication unit 1244, and a scheduler 1246, among other examples. In some configurations, one or a combination of the antenna(s) 1234, the modem(s) 1232, the MIMO detector 1236, the receive processor 1238, the transmit processor 1214, or the TX MIMO processor 1216 may be included in a transceiver of the network node 110. The transceiver may be under control of and used by one or more processors, such as the controller/processor 1240, and in some aspects in conjunction with processor-readable code stored in the memory 1242, to perform aspects of the methods, processes, or operations described herein. In some aspects, the network node 110 may include one or more interfaces, communication components, or other components that facilitate communication with the UE 120 or another network node.

The terms “processor,” “controller,” or “controller/processor” may refer to one or more controllers or one or more processors. For example, reference to “a/the processor,” “a/the controller/processor,” or the like (in the singular) should be understood to refer to any one or more of the processors described in connection with FIG. 12, such as a single processor or a combination of multiple different processors. Reference to “one or more processors” should be understood to refer to any one or more of the processors described in connection with FIG. 12. For example, one or more processors of the network node 110 may include transmit processor 1214, TX MIMO processor 1216, MIMO detector 1236, receive processor 1238, or controller/processor 1240. Similarly, one or more processors of the UE 120 may include MIMO detector 1256, receive processor 1258, transmit processor 1264, TX MIMO processor 1266, or controller/processor 1280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 11. For example, operation described as being performed by one or more memories can be performed by the same subset of the one or more memories or different subsets of the one or more memories.

For downlink communication from the network node 110 to the UE 120, the transmit processor 1214 may receive data (“downlink data”) intended for the UE 120 (or a set of UEs that includes the UE 120) from the data source 1212 (such as a data pipeline or a data queue). In some examples, the transmit processor 1214 may select one or more MCSs for the UE 120 in accordance with one or more CQIs received from the UE 120. The network node 110 may process the data (for example, including encoding the data) for transmission to the UE 120 on a downlink in accordance with the MCS(s) selected for the UE 120 to generate data symbols. The transmit processor 1214 may process system information (for example, semi-static resource partitioning information (SRPI)) or control information (for example, CQI requests, grants, or upper layer signaling) and provide overhead symbols or control symbols. The transmit processor 1214 may generate reference symbols for reference signals (for example, a cell-specific reference signal (CRS), a DMRS, or a CSI-RS) or synchronization signals (for example, a PSS or an SSS).

The TX MIMO processor 1216 may perform spatial processing (for example, precoding) on the data symbols, the control symbols, the overhead symbols, or the reference symbols, if applicable, and may provide a set of output symbol streams (for example, T output symbol streams) to the set of modems 1232. For example, each output symbol stream may be provided to a respective modulator component (shown as MOD) of a modem 1232. Each modem 1232 may use the respective modulator component to process (for example, to modulate) a respective output symbol stream (for example, for orthogonal frequency division multiplexing (OFDM)) to obtain an output sample stream. Each modem 1232 may further use the respective modulator component to process (for example, convert to analog, amplify, filter, or upconvert) the output sample stream to obtain a time domain downlink signal. The modems 1232a through 1232t may together transmit a set of downlink signals (for example, T downlink signals) via the corresponding set of antennas 1234.

A downlink signal may include a DCI communication, a MAC-CE communication, an RRC communication, a downlink reference signal, or another type of downlink communication. Downlink signals may be transmitted on a PDCCH, a PDSCH, or on another downlink channel. A downlink signal may carry one or more TBs of data. A TB may be a unit of data that is transmitted over an air interface in the wireless communication network 100. A data stream (for example, from the data source 1212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, or another parameter. In general, the larger the TB size, the greater the amount of data that can be transmitted in a single transmission, which reduces signaling overhead. However, larger TB sizes may be more prone to transmission or reception errors than smaller TB sizes, but such errors may be mitigated by more robust error correction techniques.

For uplink communication from the UE 120 to the network node 110, uplink signals from the UE 120 may be received by an antenna 1234, may be processed by a modem 1232 (for example, a demodulator component, shown as DEMOD, of a modem 1232), may be detected by the MIMO detector 1236 (for example, a receive (Rx) MIMO processor) if applicable, or may be further processed by the receive processor 1238 to obtain decoded data or control information. The receive processor 1238 may provide the decoded data to a data sink 1239 (which may be a data pipeline, a data queue, or another type of data sink) and provide the decoded control information to a processor, such as the controller/processor 1240.

The network node 110 may use the scheduler 1246 to schedule one or more UEs 120 for downlink or uplink communications. In some aspects, the scheduler 1246 may use DCI to dynamically schedule downlink transmissions to the UE 120 or uplink transmissions from the UE 120. In some examples, the scheduler 1246 may allocate recurring time domain resources or frequency domain resources that the UE 120 may use to transmit or receive communications using an RRC configuration (for example, a semi-static configuration), for example, to perform semi-persistent scheduling or to configure a configured grant (CG) for the UE 120.

One or more of the transmit processor 1214, the TX MIMO processor 1216, the modem 1232, the antenna 1234, the MIMO detector 1236, the receive processor 1238, or the controller/processor 1240 may be included in an RF chain of the network node 110. An RF chain may include one or more filters, mixers, oscillators, amplifiers, ADCs, or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 1244 to communicate with a core network or with other network nodes. The communication unit 1244 may support wired or wireless communication protocols or connections, such as Ethernet, optical fiber, common public radio interface (CPRI), or a wired or wireless backhaul, among other examples. The network node 110 may use the communication unit 1244 to transmit or receive data associated with the UE 120 or to perform network control signaling, among other examples. The communication unit 1244 may include a transceiver or an interface, such as a network interface.

The UE 120 may include a set of one or more antennas 1252 (shown as antennas 1252a through 1252r), a set of one or more modems 1254 (shown as modems 1254a through 1254u), a MIMO detector 1256, a receive processor 1258, a data sink 1260, a data source 1262, a transmit processor 1264, a TX MIMO processor 1266, a controller/processor 1280, a memory 1282, or a communication manager 150, among other examples. One or more of the components of the UE 120 may be included in a housing 1284. In some aspects, one or a combination of the antenna(s) 1252, the modem(s) 1254, the MIMO detector 1256, the receive processor 1258, the transmit processor 1264, or the TX MIMO processor 1266 may be included in a transceiver that is included in the UE 120. The transceiver may be under control of and used by one or more processors, such as the controller/processor 1280, and in some aspects in conjunction with processor-readable code stored in the memory 1282, to perform aspects of the methods, processes, or operations described herein. In some aspects, the UE 120 may include another interface, another communication component, or another component that facilitates communication with the network node 110 or another UE 120.

For downlink communication from the network node 110 to the UE 120, the set of antennas 1252 may receive the downlink communications or signals from the network node 110 and may provide a set of received downlink signals (for example, R received signals) to the set of modems 1254. For example, each received signal may be provided to a respective demodulator component (shown as DEMOD) of a modem 1254. Each modem 1254 may use the respective demodulator component to condition (for example, filter, amplify, downconvert, or digitize) a received signal to obtain input samples. Each modem 1254 may use the respective demodulator component to further demodulate or process the input samples (for example, for OFDM) to obtain received symbols. The MIMO detector 1256 may obtain received symbols from the set of modems 1254, may perform MIMO detection on the received symbols if applicable, and may provide detected symbols. The receive processor 1258 may process (for example, decode) the detected symbols, may provide decoded data for the UE 120 to the data sink 1260 (which may include a data pipeline, a data queue, or an application executed on the UE 120), and may provide decoded control information and system information to the controller/processor 1280.

For uplink communication from the UE 120 to the network node 110, the transmit processor 1264 may receive and process data (“uplink data”) from a data source 1262 (such as a data pipeline, a data queue, or an application executed on the UE 120) and control information from the controller/processor 1280. The control information may include one or more parameters, feedback, one or more signal measurements, or other types of control information. In some aspects, the receive processor 1258 or the controller/processor 1280 may determine, for a received signal (such as received from the network node 110 or another UE), one or more parameters relating to transmission of the uplink communication. The one or more parameters may include an RSRP parameter, an RSSI parameter, an RSRQ parameter, a CQI parameter, or a TPC parameter, among other examples. The control information may include an indication of the RSRP parameter, the RSSI parameter, the RSRQ parameter, the CQI parameter, the TPC parameter, or another parameter. The control information may facilitate parameter selection or scheduling for the UE 120 by the network node 110.

The transmit processor 1264 may generate reference symbols for one or more reference signals, such as an uplink DMRS, an uplink sounding reference signal (SRS), or another type of reference signal. The symbols from the transmit processor 1264 may be precoded by the TX MIMO processor 1266, if applicable, and further processed by the set of modems 1254 (for example, for DFT-s-OFDM or CP-OFDM). The TX MIMO processor 1266 may perform spatial processing (for example, precoding) on the data symbols, the control symbols, the overhead symbols, or the reference symbols, if applicable, and may provide a set of output symbol streams (for example, U output symbol streams) to the set of modems 1254. For example, each output symbol stream may be provided to a respective modulator component (shown as MOD) of a modem 1254. Each modem 1254 may use the respective modulator component to process (for example, to modulate) a respective output symbol stream (for example, for OFDM) to obtain an output sample stream. Each modem 1254 may further use the respective modulator component to process (for example, convert to analog, amplify, filter, or upconvert) the output sample stream to obtain an uplink signal.

The modems 1254a through 1254u may transmit a set of uplink signals (for example, R uplink signals or U uplink symbols) via the corresponding set of antennas 1252. An uplink signal may include a UCI communication, a MAC-CE communication, an RRC communication, or another type of uplink communication. Uplink signals may be transmitted on a PUSCH, a PUCCH, or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

One or more antennas of the set of antennas 1252 or the set of antennas 1234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 12. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 1234 or an antenna 1252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes or phases of signals transmitted via antenna elements or sub-elements may be modulated and shifted relative to each other (such as by manipulating phase shift, phase offset, or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, or a vertical direction), or a set of parameters that indicate one or more aspects of a directional signal, a direction associated with the signal, or a set of directional resources associated with the signal. In some implementations, antenna elements may be individually selected or deselected for directional transmission of a signal (or signals) by controlling amplitudes of one or more corresponding amplifiers or phases of the signal(s) to form one or more beams. The shape of a beam (such as the amplitude, width, or presence of side lobes) or the direction of a beam (such as an angle of the beam relative to a surface of an antenna array) can be dynamically controlled by modifying the phase shifts, phase offsets, or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 124 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Sidelink communication between a pair of UEs 120 (e.g., UE 120a and UE 120e) may employ the elements for UE 120 shown and described in FIG. 12 for each UE of the pair of UEs 120, where transmission of uplink signals or communication by a UE 120 as described in FIG. 12 now refers to transmission of sidelink communication or signals by the UE 120, and where reception of downlink signals or communication by a UE 120 as described in FIG. 12 now refers to reception of sidelink signals or communication by the UE 120. Additionally, the UE 120 may employ the elements of the UE 120 shown and described in FIG. 12 for satellite communications or communications with other network entities (e.g., to perform transmission of uplink signals or reception of downlink signals).

The UE 120 may obtain a location estimate for the UE 120 using position techniques such as GPS, A-GPS, A-GNSS, OTDOA, ECID, WLAN positioning (e.g., using signals transmitted by IEEE 802.11 WiFi access points), or sensors 1286 in the UE 120. For example, the sensors 1286 may include one or more inertial sensors. Here, the controller/processor 1280 of the UE 120 may obtain data from the sensors 1286 to obtain or refine a location estimate for the UE 120. Additionally, the UE 120 may rely on one or more signals received by the UE 120 (e.g., via one or more of the communication manager 150, the antenna 1252, the modem 1254, the MIMO detector 1256, or the receive processor 1258) to perform (e.g., using the controller/processor 1280) techniques such as GPS, A-GPS, A-GNSS, OTDOA, ECID, or WLAN positioning in order to obtain a location estimate for the UE 120. The UE 120 may use a location estimate for the UE 120 to determine or help determine whether the UE 120 is in a target area for an emergency alert message or is in a geographic area indicated by a relay geographic area type, or whether the UE 120 is to forward an emergency alert message in accordance with a store-and-forward operation.

In some aspects, a UE 120 may include means for receiving, at a first time, an emergency alert message that indicates an alerting event. The means for the UE 120 to receive the emergency alert message may include, for example, one or more of the communication manager 150, the antenna 1252, the modem 1254, the MIMO detector 1256, or the receive processor 1258. In some aspects, the UE 120 may include means for performing a store-and-forward operation associated with the emergency alert message. For example, the means for storing the emergency alert message may include, for example, one or more of the receive processor 1258, the controller/processor 1280, the memory 1282, or the communication manager 150. Additionally, the means for determining to forward the emergency alert message (e.g., as part of the store-and-forward operation) may include, for example, one or more of the sensors 1286, the controller/processor 1280, or the communication manager 150. In some aspects, the UE 120 may include means for transmitting, to a second UE via a sidelink interface and at a second time that occurs after the first time, an indication of both the emergency alert message and a store-and-forward operation associated with the emergency alert message. The means for the UE 120 to transmit the indication of the both the emergency alert message and the store-and-forward operation associated with the emergency alert message may include, for example, one or more of the modem 1254, the transmit processor 1264, the TX MIMO processor 1266, the controller/processor 1280, or the memory 1282. In some aspects, the UE 120 may include means for transmitting, via the sidelink interface and at a third time that occurs at or after the second time, the emergency alert message to the second UE in accordance with the store-and-forward operation. The means for the UE 120 to transmit the emergency alert message to the second UE may include, for example, one or more of the modem 1254, the transmit processor 1264, the TX MIMO processor 1266, the controller/processor 1280, or the memory 1282.

While blocks in FIG. 12 are illustrated as distinct components, the functions described above with respect to the blocks may be implemented in a single hardware, software, or combination component or in various combinations of components. For example, the functions described with respect to the transmit processor 1264, the receive processor 1258, or the TX MIMO processor 1266 may be performed by or under the control of the controller/processor 1280.

As indicated above, FIG. 12 is provided as an example. Other examples may differ from what is described with regard to FIG. 12.

The following provides an overview of some Aspects of the present disclosure:

Aspect 1: A method of wireless communication performed by a first UE, comprising: receiving, at a first time, an emergency alert message that indicates an alerting event; transmitting, to a second UE via a sidelink interface and at a second time that occurs after the first time, an indication of both the emergency alert message and a store-and-forward operation associated with the emergency alert message; and transmitting, via the sidelink interface and at a third time that occurs at or after the second time, the emergency alert message to the second UE in accordance with the store-and-forward operation.

Aspect 2: The method of Aspect 1, further comprising: receiving signaling indicating that the emergency alert message can be transmitted in accordance with the store-and-forward operation, wherein transmitting the emergency alert message in accordance with the store-and-forward operation is based at least in part on the signaling.

Aspect 3: The method of any of Aspects 1-2, wherein receiving the emergency alert message comprises receiving a first plurality of segments that correspond to the emergency alert message, and wherein the method further comprises: reassembling the emergency alert message based at least in part on combining the first plurality of segments, wherein transmitting the emergency alert message is based at least in part on the reassembling.

Aspect 4: The method of Aspect 3, wherein transmitting the emergency alert message to the second UE comprises transmitting the reassembled emergency alert message.

Aspect 5: The method of Aspect 3, further comprising: dividing the reassembled emergency alert message into a second plurality of segments that correspond to the reassembled emergency alert message, wherein a first maximum size of each of the first plurality of segments is different from a second maximum size of each of the second plurality of segments, and wherein transmitting the emergency alert message to the second UE comprises transmitting the second plurality of segments to the second UE.

Aspect 6: The method of any of Aspects 1-5, further comprising: receiving, at a fourth time that occurs prior to the first time, configuration information associated with store-and-forward operations at the first UE, wherein transmitting the emergency alert message is based at least in part on the configuration information.

Aspect 7: The method of Aspect 6, wherein the configuration information indicates one or more of whether the first UE is allowed to transmit emergency alert messages in accordance with immediate broadcast operations, whether the first UE is allowed to transmit emergency alert messages in accordance with store-and-forward operations, one or more source devices for emergency alert messages that the first UE is allowed to transmit with store-and-forward operations, an indication of a maximum duration between the first UE receiving an emergency alert message and no longer transmitting the emergency alert message, a type of geographic area (e.g., a relay geographic area type) associated with transmitting emergency alert messages, an indication of a maximum number of hops for the store-and-forward operations, one or more identifiers of emergency alert messages that the first UE is allowed to transmit according to immediate broadcast operations or according to store-and-forward operations, or a periodicity of broadcast transmissions for the store-and-forward operations.

Aspect 8: The method of any of Aspects 1-7, further comprising: receiving, at the first time and with the emergency alert message, configuration information associated with the store-and-forward operation for the emergency alert message, wherein transmitting the emergency alert message is based at least in part on the configuration information.

Aspect 9: The method of Aspect 8, wherein the configuration information indicates one or more of whether the first UE is allowed to transmit the emergency alert message in accordance with an immediate broadcast operation, whether the first UE is allowed to transmit the emergency alert message in accordance with the store-and-forward operation, one or more source devices for emergency alert messages that the first UE is allowed to transmit with store-and-forward operations, a type of the first UE allowed to transmit emergency alert messages with store-and-forward operations, an indication of a maximum duration between the first UE receiving the emergency alert message and no longer transmitting the emergency alert message during the store-and-forward operation, a geographic area (e.g., a relay geographic area type) associated with transmitting the emergency alert message in accordance with the store-and-forward operation, an indication of a maximum number of hops for the store-and-forward operations, or a periodicity of broadcast transmissions of the emergency alert message in accordance with the store-and-forward operation.

Aspect 10: The method of any of Aspects 1-9, wherein transmitting the indication and the emergency alert message comprises broadcasting a message that comprises the indication and the emergency alert message.

Aspect 11: The method of Aspect 10, wherein broadcasting the message comprises broadcasting the message according to a periodicity associated with the store-and-forward operation.

Aspect 12: The method of Aspect 11, wherein the periodicity associated with the store-and-forward operation is based at least in part on a quantity of UEs broadcasting, to the first UE, one or more emergency alert messages.

Aspect 13: The method of Aspect 10, wherein the indication corresponds to a destination layer 2 identifier that is associated with the emergency alert message and that indicates that the emergency alert message is associated with the store-and-forward operation.

Aspect 14: The method of Aspect 10, wherein the message further comprises one or more of an identifier associated with a source device of the emergency alert message, an indication of whether the emergency alert message can be transmitted in accordance with store-and-forward operations, authentication information for the emergency alert message, a geographic area or a type of geographic area (e.g., a relay geographic area type) associated with broadcasting the emergency alert message, an indication of a maximum time duration associated with broadcasting the emergency alert message, a periodicity associated with broadcasting the emergency alert message, or an indication of a maximum number of hops associated with broadcasting the emergency alert message.

Aspect 15: The method of any of Aspects 1-14, wherein transmitting the indication comprises transmitting a discovery initiation message that comprises the indication of both the emergency alert message and the store-and-forward operation associated with the emergency alert message, and wherein the method further comprises: receiving, from the second UE, a response to the discovery initiation message, wherein transmitting the emergency alert message to the second UE is based at least in part on the response.

Aspect 16: The method of Aspect 15, wherein the indication corresponds to a relay service code within the discovery initiation message that is indicative of the emergency alert message and the store-and-forward operation associated with the emergency alert message.

Aspect 17: The method of Aspect 15, wherein the discovery initiation message further comprises one or more of an indication of a quantity of emergency alert messages stored at the first UE, an indication of a quantity of hops between a source device of the emergency alert message and the first UE, an indication of an age of the emergency alert message, an identifier associated with the emergency alert message, a serial number associated with the emergency alert message, or an identifier associated with a source device of the emergency alert message.

Aspect 18: The method of Aspect 15, further comprising: establishing a unicast connection (e.g., a sidelink RRC connection) with the second UE based at least in part on the response to the discovery initiation message, wherein transmitting the emergency alert message comprises transmitting the emergency alert message via the unicast connection.

Aspect 19: The method of Aspect 15, wherein the response to the discovery initiation message comprises an indication of the emergency alert message, and wherein transmitting the emergency alert message to the second UE is based at least in part on the response to the discovery initiation message comprising the indication of the emergency alert message.

Aspect 20: The method of any of Aspects 1-19, further comprising: receiving, from the second UE, a discovery request message that indicates that a purpose of the discovery request message is to receive the emergency alert message, wherein transmitting the emergency alert message to the second UE is based at least in part on the discovery request message.

Aspect 21: The method of Aspect 20, further comprising: establishing a unicast connection (e.g., a sidelink RRC connection) with the second UE based at least in part on the discovery request message, wherein transmitting the indication and the emergency alert message comprises transmitting the indication and the emergency alert message via the unicast connection.

Aspect 22: The method of any of Aspects 1-21, further comprising: transmitting, via the sidelink interface to the second UE, authentication information associated with the first UE, wherein the authentication information includes a public key certificate associated with the first UE, wherein the authentication information enables the second UE to authenticate the first UE.

Aspect 23: The method of any of Aspects 1-22, further comprising: receiving, at a fourth time that occurs prior to the first time, an initial emergency alert message that indicates the alerting event; storing the initial emergency alert message at the first UE in accordance with the store-and-forward operation; and replacing the stored initial emergency alert message with the emergency alert message based at least in part on receiving the emergency alert message after receiving the initial emergency alert message, and the initial emergency alert message and the emergency alert message being associated with a same identifier, wherein transmitting the emergency alert message is based at least in part on the replacing.

Aspect 24: The method of any of Aspects 1-23, wherein the emergency alert message is a wireless emergency alert (WEA) message.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

Aspect 32: A device comprising a processing system that includes one or more processors and one or more code-storing memories coupled with the one or more processors, the processing system configured to cause the device to perform the method of one or more of Aspects 1-24.

Aspect 33: A device comprising a processing system that includes processor circuitry and code-storing memory circuitry, the processing system configured to cause the device to perform the method of one or more of Aspects 1-24.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, at a first time, an emergency alert message that indicates an alerting event;
transmit, to a second UE via a sidelink interface and at a second time that occurs after the first time, an indication of both the emergency alert message and a store-and-forward operation associated with the emergency alert message; and
transmit, via the sidelink interface and at a third time that occurs at or after the second time, the emergency alert message to the second UE in accordance with the store-and-forward operation.

2. The UE of claim 1, wherein the processing system is configured to cause the UE to:
receive signaling indicating that the emergency alert message can be transmitted in accordance with the store-and-forward operation, wherein transmitting the emergency alert message in accordance with the store-and-forward operation is based at least in part on the signaling.

3. The UE of claim 1, wherein receiving the emergency alert message comprises receiving a first plurality of segments that correspond to the emergency alert message, and wherein the processing system is configured to cause the UE to:
reassemble the emergency alert message based at least in part on combining the first plurality of segments, wherein transmitting the emergency alert message is based at least in part on the reassembling.

4. The UE of claim 3, wherein the processing system, to cause the UE to transmit the emergency alert message to the second UE, is configured to cause the UE to transmit the reassembled emergency alert message.

5. The UE of claim 3, wherein the processing system is configured to cause the UE to:
divide the reassembled emergency alert message into a second plurality of segments that correspond to the reassembled emergency alert message, wherein a first maximum size of each of the first plurality of segments is different from a second maximum size of each of the second plurality of segments, and wherein transmitting the emergency alert message to the second UE comprises transmitting the second plurality of segments to the second UE.

6. The UE of claim 1, wherein the processing system is configured to cause the UE to:
receive, at a fourth time that occurs prior to the first time, configuration information associated with store-and-forward operations at the UE, wherein transmitting the emergency alert message is based at least in part on the configuration information.

7. The UE of claim 1, wherein the processing system is configured to cause the UE to:
receive, at the first time and with the emergency alert message, configuration information associated with the store-and-forward operation for the emergency alert message, wherein transmitting the emergency alert message is based at least in part on the configuration information.

8. The UE of claim 1, wherein the processing system, to cause the UE to transmit the indication and the emergency alert message, is configured to cause the UE to broadcast a message that comprises the indication and the emergency alert message.

9. The UE of claim 8, wherein the processing system, to cause the UE to broadcast the message, is configured to cause the UE to broadcast the message according to a periodicity associated with the store-and-forward operation.

10. The UE of claim 9, wherein the periodicity associated with the store-and-forward operation is based at least in part on a quantity of UEs broadcasting, to the UE, one or more emergency alert messages.

11. The UE of claim 8, wherein the indication corresponds to a destination layer 2 identifier that is associated with the emergency alert message and that indicates that the emergency alert message is associated with the store-and-forward operation.

12. The UE of claim 1, wherein transmitting the indication comprises transmitting a discovery initiation message that comprises the indication of both the emergency alert message and the store-and-forward operation associated with the emergency alert message, and wherein the processing system is configured to cause the UE to:
receive, from the second UE, a response to the discovery initiation message, wherein transmitting the emergency alert message to the second UE is based at least in part on the response.

13. The UE of claim 12, wherein the indication corresponds to a relay service code within the discovery initiation message that is indicative of the emergency alert message and the store-and-forward operation associated with the emergency alert message.

14. The UE of claim 12, wherein the processing system is configured to cause the UE to:
establish a unicast connection with the second UE based at least in part on the response to the discovery initiation message, wherein transmitting the emergency alert message comprises transmitting the emergency alert message via the unicast connection.

15. The UE of claim 12, wherein the response to the discovery initiation message comprises an indication of the emergency alert message, and wherein transmitting the emergency alert message to the second UE is based at least in part on the response to the discovery initiation message comprising the indication of the emergency alert message.

16. The UE of claim 1, wherein the processing system is configured to cause the UE to:
receive, from the second UE, a discovery request message that indicates that a purpose of the discovery request message is to receive the emergency alert message, wherein transmitting the emergency alert message to the second UE is based at least in part on the discovery request message.

17. The UE of claim 1, wherein the processing system is configured to cause the UE to:
transmit, via the sidelink interface to the second UE, authentication information associated with the UE, wherein the authentication information includes a public key certificate associated with the UE, wherein the authentication information enables the second UE to authenticate the UE.

18. The UE of claim 1, wherein the processing system is configured to cause the UE to:
receive, at a fourth time that occurs prior to the first time, an initial emergency alert message that indicates the alerting event;
store the initial emergency alert message at the UE in accordance with the store-and-forward operation; and
replace the stored initial emergency alert message with the emergency alert message based at least in part on receiving the emergency alert message after receiving the initial emergency alert message, and the initial emergency alert message and the emergency alert message being associated with a same identifier, wherein transmitting the emergency alert message is based at least in part on the replacing.

19. A method of wireless communication performed by a first user equipment (UE), comprising:
receiving, at a first time, an emergency alert message that indicates an alerting event;
transmitting, to a second UE via a sidelink interface and at a second time that occurs after the first time, an indication of both the emergency alert message and a store-and-forward operation associated with the emergency alert message; and
transmitting, via the sidelink interface and at a third time that occurs at or after the second time, the emergency alert message to the second UE in accordance with the store-and-forward operation.

20. A non-transitory computer-readable medium storing a set of instructions for wireless communication, the set of instructions comprising:
one or more instructions that, when executed by one or more processors of a user equipment (UE), cause the UE to:
receive, at a first time, an emergency alert message that indicates an alerting event;
transmit, to a second UE via a sidelink interface and at a second time that occurs after the first time, an indication of both the emergency alert message and a store-and-forward operation associated with the emergency alert message; and
transmit, via the sidelink interface and at a third time that occurs at or after the second time, the emergency alert message to the second UE in accordance with the store-and-forward operation.
